(19) United States
(12) Patent Application Publication
(10) Pub. No.: US 2020/0302296 A1
(43) Pub. Date: Sep. 24, 2020

(54) SYSTEMS AND METHOD FOR OPTIMIZING EDUCATIONAL OUTCOMES USING ARTIFICIAL INTELLIGENCE

(71) Applicant: D. Douglas Miller, Martinez, GA (US)

(72) Inventor: D. Douglas Miller, Martinez, GA (US)

(21) Appl. No.: 16/825,815

(22) Filed: Mar. 20, 2020

Related U.S. Application Data
(60) Provisional application No. 62/821,881, filed on Mar. 21, 2019.

(51) Int. Cl. G06N 3/08; G06N 3/04; G06F 16/23; G06F 16/25; G09B 7/00

(52) U.S. Cl. CPC G06N 3/08; G06N 3/0427; G09B 7/00; G06F 16/252; G06F 16/2379

(57) ABSTRACT

The present invention is directed, in one particular implementation, to a cloud computing-based categorization system that comprises at least one electronic database having one or more performance assessment data associated with a plurality of entities matriculated at one or more educational institutions. The system further includes a processor, communicatively coupled to the at least one database, and configured to execute an electronic process that analyzes and converts said performance assessment data. Through one or more modules, the processor is configured to select performance assessment data corresponding to at least one structured assessment data value; and at least one unstructured assessment data set for an individual and evaluate the structured and un-structed data of the individual using an assessment model configured to classify the entity into one of a plurality of assessment categories. The processor is further configured by one or more modules to generate a graphical representation, for display and output to one or more remote users, of the likelihood that the individual is assigned to one of the plurality of assessment categories.

### CROSS REFERENCE TO RELATED APPLICATION

The present application claims the benefit of priority under 35 U.S.C. § 119(e) of U.S. Application No. 62/821,881, filed Mar. 21, 2019, which is hereby incorporated by reference in its entirety.

### FIELD OF THE INVENTION

The systems, methods and apparatus described herein are directed to the evaluation of educational content models and generation of optimized content designed to enhance proficiency in a particular subject area and improve learner confidence in retained knowledge. In a further implementation, the precision education systems, methods and apparatus described herein are directed to generating individualized educational and career analytics, benchmarking and evaluations using historical and present datasets.

### BACKGROUND OF THE INVENTION

Medical professionals struggle to keep pace with rapidly expanding scientific knowledge and unpredictable healthcare system changes. In this complex, high-stakes environment, medical schools and students face growing expectations of academic rigor and active learning in health curricula. Advances in machine/deep learning (i.e., artificial intelligence, AI) are now impacting the business of healthcare and the practice of medicine.

Scientific output doubles every three years. Post-graduate schools (e.g. medical schools and graduate medical education (GME) training programs) sit squarely at the nexus of the digital technology explosion and a massive growth in scholarly peer-reviewed biomedical information (below). Undergraduate programs, M.D. and GME programs are also the high-stakes homes of critical professional competency assessments leading to professional licensing (e.g. medical) and specialty credentialing.

The unprecedented acceleration of scientific discoveries and the increasing complexity of healthcare best practices now far exceed the capacity of medical students and other trainees to receive absorb and retain all relevant information. However, this body of published knowledge and other data repositories must be applied to optimize healthcare. This dichotomy is stressing medical schools & learners and is negatively impacting healthcare systems' ability to consistently deliver reliable, safe & high-quality care.

Innovations such as the electronic health record (EHR), miniaturized microprocessors in medical devices and telemedicine have lagged and/or been unevenly implemented, despite evidence that these technologies measurably enhance secure sharing of personal health information, quality of life and remote access to advanced healthcare. A proximate cause of this healthcare technology adoption lag is the failure of medical educators to better prepare learners to be early adopters before they enter the clinical workplace.

Additionally, medical professionals struggle to keep pace with rapidly expanding scientific knowledge and unpredictable healthcare system changes. In this complex high-stakes environment, medical schools and students face growing expectations of academic rigor and active learning in health curricula. Advances in machine/deep learning (i.e., artificial intelligence, AI) are now impacting the business of healthcare and the practice of medicine.

No educational cohort is more comprehensively sampled and studied than the medical students of the United States and Canada. Extensive structured data is acquired on medical school applicants, matriculants, students and graduates, using diverse required forms, standardized tests (i.e., USMLE exams, etc.) and voluntary opinion samplings (i.e., surveys). Between application to graduation, thousands of discrete data elements per student are captured, resulting in hundreds of millions of individual data points.

This learner information, often collected in a confidential and/or anonymous fashion, is de-identified and compiled into databases characterizing cohorts by class year and over four-years in medical school. Such data routinely undergo standard statistical analysis within medical schools (for curriculum management, program reaccreditation purposes, etc.), across schools participating in national data repositories (for physician workforce planning, public advocacy, etc.), and in learner subsets reported in the peer-reviewed literature (from research consortia, via data sharing/warehousing agreements).

The long-held potential of artificial intelligence (AI), whether classified as machine learning (ML) or deep learning (DL), is now being realized as a result of nearly unlimited Cloud-based computing capacity. Massive digital data sets, whether structured or unstructured, can now be screened using iterative algorithms (computer programmed Q&A) at processing speeds that far exceed human cognitive capacity.

For example, IBM Watson is a NLP AI problem-solving technology that has found numerous scientific and business applications, including life sciences, oncology/genomics, medical imaging, value-based healthcare, government programs and consumer health. The AI health business model primarily targets current users—scientists, doctors, Big Pharma, clinical trialists and healthcare executives—as the basis for platform adoption and product purchase.

Not yet considered, but potentially as important, are the future users of AI health applications—medical students, GME residents, and other healthcare trainees—learners who become early adopters of this technology, and who will become leaders in a rapidly changing system of data science-infused healthcare.

However, educational curriculum remains rooted in traditional, one size fits all models. Different learners have different skill sets, abilities, stressors and other factors that contribute to disparate outcomes irrespective of knowledge, skill or talent.

One of the problems in need of a solution is the lack of ability to harmonize the educational assessment, career outcome, emotional stressors, and other data relating to individual students across all educational institutions. As such, where a certain set of factors for a student at a first educational institution might predict career success, similar factors for a student at a different educational institution might not yield accurate predictions about career success. Thus, what is needed is a way to harmonize disparate datasets into a single mappable visualization that details where a student lies relative to one's peers. Furthermore, the art lacks suitable systems and methods for tailoring an academic program for a student that considers not only current career ambitions, but also the probabilities that similar students have achieved such ambitions. More precisely, what is needed in the art are one or more precision education technology platform designed to consolidate disparate data about professional education and knowledge transfer that exploits the individual adaptability and diversity of learners. Furthermore, what is needed is an approach to clean & orientate data collected from a number of sources so as to prepare for the data for analytics. More specifically, what is needed are appropriate extract-load-transfer (ETL) data steps that are required to perform on user data before a database can be queried a computer operating an AI program.

Thus, what is needed in the art are systems, method and apparatus that evaluate educational data using machine or artificial intelligence concepts and generate improved or optimized learning content or outcomes in response to the evaluation. For example, what is needed is an AI technology platform designed to consolidate disparate data about professional education and knowledge transfer that exploits the individual adaptability and diversity of learners.

Likewise, medical schools (and other schools) have a need for computer mediated methods and systems that alleviate or ameliorate the barriers associated with student advising on career choice planning and life-work balance. Thus, what is needed are systems and methods for providing active monitoring of likely candidates for early burnout, or those students having an increased likelihood of failure.

### SUMMARY OF THE INVENTION

Embodiments of the invention are directed towards systems, methods and computer program products for accessing data relating to collections of students and generating data visualizations, such as but not limited to, data clusters, that indicate students having similar learning trajectory or probable outcomes.

In a further implementation, one or more systems, methods and computer program products are provided for generating new or customized educational content in response to the application of one or more metrics correlated with improved learner outcome.

In a further configuration, one or more systems, methods and computer program products are provided for accessing and compiling from one or more datastores of student evaluation materials, one or more values indicative of a probable success in an academic program.

In yet a further implementation, one or more systems, methods and computer program products are provided for implementing one or more models to be utilized by a cloud-based platform to generate personalized predictive information that is then deployed in real- and near-real time to assist learner and educators with individual learner career planning, lifestyle management, and other key decisions during and after college, post-graduate or professional school. Likewise, such computer implemented methods are utilized to generate alerts, notifications or indications of a learner's wellbeing and otherwise provide actionable data points that alleviate the struggle associated with student advising on career choice planning and life-work balance. Such described platforms provide active monitoring of likely candidates for early burnout, or those students having an increased likelihood of failure detection and prompts educators or administrators for attention, monitoring or intervention.

In yet a further implementation, one or more systems, methods and computer program products that evaluate a particular student's evaluation material and assign the student to a category of previously assigned students. The system is further configured, by code executing in one or more processors, to evaluate a particular evaluated individual and generate a tailored curriculum to move that student to a different cohort. For example, where the cohort a learner is most closely associated with a cohort that typically has unfavorable outcomes, the system is configured to automatically generate a curriculum designed to address assessment metrics in order to move the learner into a new cohort with more favorable outcomes. For instance, the system is configured to generate a new academic plan for a learner that puts emphasis on identified items or skill sets in need of improvement.

In one or more systems, methods and computer implemented products described herein, a processor is configured to use one or predictive algorithms to classify entries of a corpus of data according to its relevance to subject matter proficiency. Such as described systems, methods and computer implemented products are further configured by one or more processors, executing a predictive module or algorithm, to generate new or optimized content using having one or more features in common with the classified content predicted to have relevancy to subject matter proficiency.

An alternative embodiment relates to one or more machine learning or other artificially intelligent systems, that when applied to large medical student databases, manipulate or configure individual student profiles (such, student profiles can be referred to as “Edu-maps”) so as to predict individual or composite/global student outcomes (i.e., success, resilience, etc.) for a student population. In a further implementation, the level of confidence for predicting individual student outcomes via CNN (convolutional neural networks) or RNN (recurrent neural networks) training is enhanced by using curated databases populated by Edu-map program enrolled medical students and validated through a consortium of North American medical schools.

In a further implementation, the Edu-maps are used to implement personalized predictive information to assist in individual career planning, lifestyle management, and other key decisions during and after medical school for students. In an alternative configuration, the Edu-maps are used for any professional, practical, career or other educational environment.

It will be appreciated by those possessing requisite level of skill in the relative arts that the systems, methods and computer products are provided that generate one or more outputs used to adjust or sort a member of an educational institution into a different educational cohort. For example, the systems, methods and apparatus are applicable to evaluating students in legal, business, scientific, trade or other non-degree, graduate, certificate, and post-graduate academic programs.

In yet a still further implementation, a cloud-based categorization system is provided that comprises an electronic database having one or more categories of performance assessment data associated with a plurality of entities matriculated at an educational institution, wherein the electronic database is operatively coupled to a computer program product having a computer-usable medium having a sequence of instructions which, when executed by a processor, causes said processor to execute an electronic process that analyzes and converts said performance assessment data.

Here, the electronic process comprises selecting performance assessment data corresponding to at least (a) structured assessment data values and (b) at least one unstructured assessment data set. As used herein, unstructured datasets can refer to data that is not easily or readily quantifiable (e.g. subjective assessments of a learner or their work product). The process continues by evaluating the structured and unstructured data using an assessment model configured to classify the entity into one of a plurality of assessment categories and then comparing the classified assessment value against a pre-determined threshold value. Where the classified value is below the pre-determined threshold one or more processors are configured to adjust at least a portion of the structured assessment value by a pre-determined amount. Upon adjustment, one or more processors is further configured to reevaluate the adjusted structured assessment value and at least one unstructured assessment with the assessment module and, where the adjusted assessment value has a classified assessment value above the pre-determined threshold value, the processor is configured to generate a graphical representation of the value of difference in the value of the structured assessment value and the adjusted assessment value.

### BRIEF DESCRIPTION OF THE DRAWINGS

The present invention is illustrated in the figures of the accompanying drawings which are meant to be exemplary and not limiting, in which like references are intended to refer to like or corresponding parts, and in which:

FIG. 1 illustrates a diagram of a system for evaluating and generating optimized educational content according to one embodiment of the present invention.

FIG. 2 presents a flow diagram of the steps for evaluating and generating optimized educational content according to one embodiment of the present invention.

FIG. 3A presents a block diagram illustrating a processor configured by a set of modules to implement the steps evaluating and generating optimized educational content according to one embodiment of the present invention.

FIG. 3B presents a block diagram illustrating a processor configured by a set of modules to implement the steps training an analytical model according to one embodiment of the present invention

FIG. 4 presents a flow diagram a particular arrangement of current models.

FIG. 5 presents a block diagram illustrating the component of the system in accordance with a particular aspect of the present invention.

FIG. 6 presents a block diagram illustrating the component of the system in accordance with a particular aspect of the present invention.

FIG. 7 presents a block diagram illustrating the component of the system in accordance with a particular aspect of the present invention.

FIG. 8 presents a block diagram illustrating the component of the system in accordance with a particular aspect of the present invention.

FIG. 9 presents a diagram illustrating evaluative component of the system described herein.

FIG. 10 illustrates a chart detailing information concerning in Example 1 described herein.

FIG. 11 provides a table of data concerning in Example 1 described herein.

FIG. 12 provides a table of data concerning in Example 1 described herein.

FIG. 13 provides a cluster views of data concerning in Example 1 described herein.

FIG. 14 provides a table of data concerning in Example 1 described herein.

FIG. 15 provides a heat map of data concerning in Example 1 described herein.

FIG. 16 provides a chart of data concerning in Example 2 described herein.

FIG. 17A provides a table of data concerning Example 2 described herein.

FIG. 17B provides a table of data concerning Example 2 described herein.

FIG. 18A provides a table of data concerning Example 2 described herein.

FIG. 18B provides a table of data concerning Example 2 described herein.

FIG. 18C provides a table of data concerning Example 2 described herein.

FIG. 19A provides a table of data concerning Example 2 described herein.

FIG. 19B provides a table of data concerning Example 2 described herein.

FIG. 20 provides a graphical user interface of data concerning Example 2 described herein.

FIG. 21 provides a graphical user interface of data concerning Example 2 described herein.

FIG. 22 provides a graphical user interface of data concerning Example 2 described herein.

FIG. 23 provides a graphical user interface of data concerning Example 2 described herein.

FIG. 24 provides a graphical user interface of data concerning Example 2 described herein.

FIG. 25 provides a graphical user interface of data concerning Example 2 described herein.

FIG. 26 provides a graphical user interface of data concerning Example 2 described herein.

FIG. 27 provides a graphical user interface of data concerning Example 2 described herein.

FIG. 28 provides a graphical user interface of data concerning Example 2 described herein.

FIG. 29 provides a graphical user interface of data concerning Example 2 described herein.

FIG. 30 provides a graphical user interface of data concerning Example 2 described herein.

FIG. 31 provides a graphical user interface of data concerning Example 2 described herein.

### DETAILED DESCRIPTION OF CERTAIN EMBODIMENTS OF THE INVENTION

By way of overview, various embodiments of the systems and methods described herein are directed towards evaluating educational assessment data and generating predictive models that allow the production of customized outputs for particular users. For instance, in one implementation, the systems described herein are configured to evaluate educational data for a specific learner so as to produce visualizations demonstrating the similarity of a given learner to none or more categorized cohorts of learners. In further embodiments of the systems, methods and computer products described, such generated predictive models are used to provide customized, ameliorative, or remedial action profiles to assist students with achieving academic and career goals.

With more specificity, the systems, methods and computer implemented products described herein extract learner data from a collection of discrete educational databases and utilize AI based principals to construct predictive models relating to likelihood of educational or career success. Once generated, such predictive models are used to evaluate individual students for likelihood of success in future efforts or endeavors. By identifying the difference between one or more members of a first cohort and the average or general characteristics of a second cohort, a customized or tailored educational profile is generated that has a high likelihood of causing the member of the first cohort to move to the second cohort. Thus, in a particular implementation, the systems and methods described herein utilize access to a large cohort of skilled, validated medical and AI based evaluation models to provide customized training and feedback to the students and educators. For instance, the AI based evaluation modules are used to generate classifiers that receive structured and unstructured data relating to a specific learner and classify the probability that the learner fits into one or more educational cohorts. Additionally, the AI based evaluation modules can be used to review and interpret the likelihood that a given selection of evaluative materials (e.g. tests) are accurate predictors or future academic or career success. Likewise, educational materials can further be classified according the likelihood that such materials are correlated with improved academic outcomes.

In an alternative embodiment, apparatus, systems and methods described herein are also directed to the generation of optimized or novel curriculum developed for medical and health professionals based on salient AI principles (i.e., machine learning [ML]/deep learning [DL], pattern recognition/natural language processing [NLP] algorithms, evidence-based predictive analytics, etc.).

### Overview

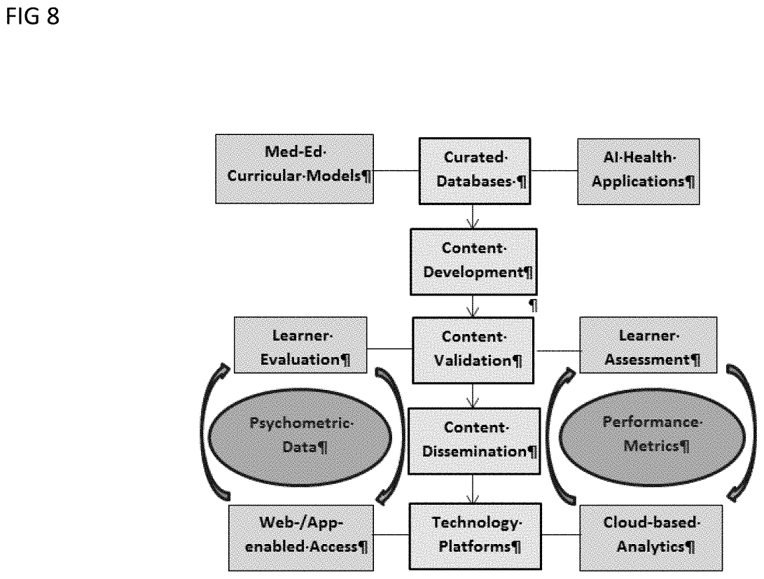

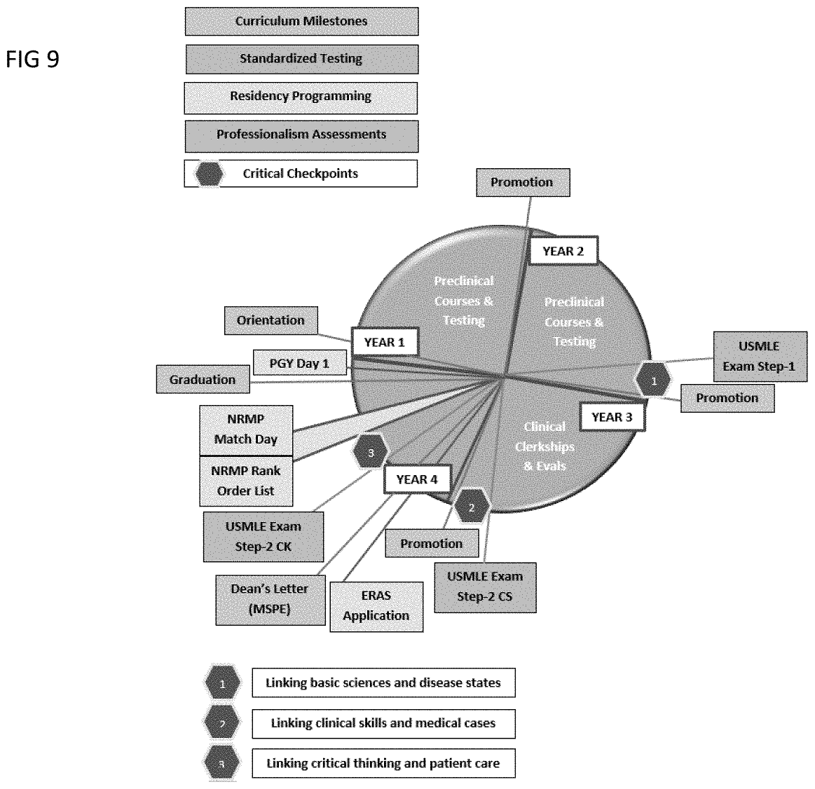

As a broad overview, those possessing an ordinary level of skill in the requisite art appreciate that individual educational milestones and professional outcomes are highly interdependent. By evaluating near term academic outcomes for students, it becomes possible to predict future career outcomes. In more detail, a students' educational milestones and personal attributes are necessarily inter-related in all professional school's disciplines. Academic achievement and professionalism are also purposefully linked as requirements for professional school degree granting. In the aggregate, the diverse data elements grouped in broad educational/academic and personal/ professional categories comprise complex profiles of large learner cohorts pursuing standardized pathways towards completion of common professional school program requirements. For example, FIG. 9 details a lifecycle of medical school milestones and checkpoints (e.g. course load, assessments & evaluations, graduation pre-requisites). Such standardized data can be used in connection with AI and machine learning (ML) techniques to provide actionable data relating to learners' near and long-term success.

Aggregated, diverse, high-quality cohort data is thus usable for both analytic purposes and generating customized lesson plans of educational profiles. Here, large data sets of student assessments (e.g. tests) and professionalism evaluations (e.g. recommendations or evaluations) are transformed into easily comprehensible visualizations (e.g. clusters or heatmaps) that highlight the predictive outcome of learners based on historical data.

Furthermore, based on individual-to-cluster relatedness, the probability of academic milestone success during the individual professional school program can be evaluated and compensated. In addition, a student's individual ‘fit’ (i.e. their readiness for more career advanced training, passage of required licensing exams, successful workforce entry & subsequent career durability fit) can be predicted separately using predictive models based on a combination of structured and unstructured student data. Thus, in one implementation, predictive and analytics tools are used to analyze, decode, and/or de-convolute big data from professional school learner databases in order to generate virtual maps that represent solutions for individual learners. These visual representations provide an academic path for the learner having the highest likelihood of success and which particular personal traits are most closely associated with successful career development.:

In an alternative configuration, the systems, methods and computer implemented products described herein are directed to evaluating a collection of information sources, such as various educational models and content, to determine which, if any, information source presents information in a format optimized for retention by users. In another particular implementation, a collection of datasets (e.g. a set or compendium of questions and corresponding answers administered as part of various professional licensing exams) are evaluated to determine which elements of the dataset are optimized to evaluate factual retention or subject matter proficiency.

### System Architecture

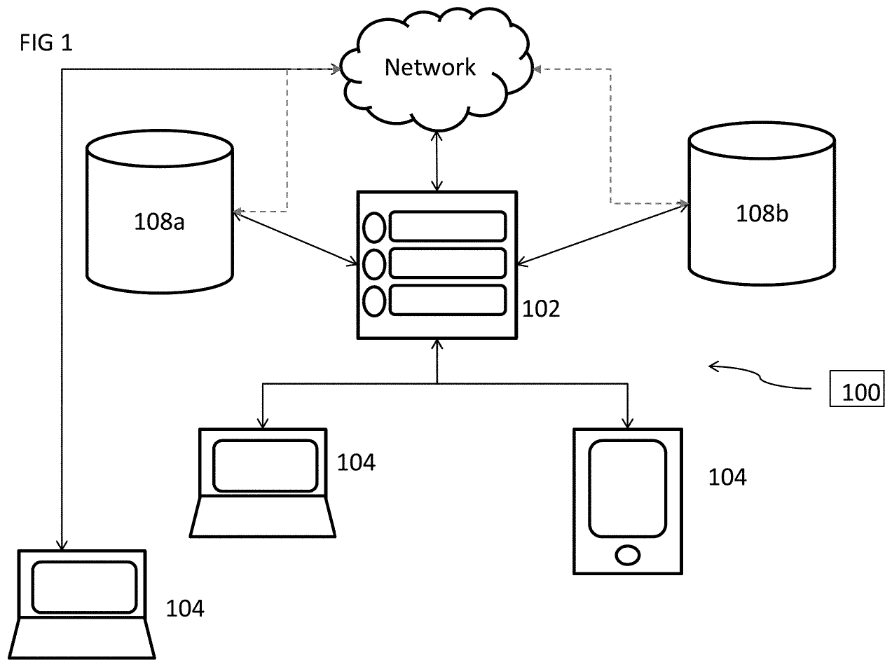

With particular reference to FIG. 1, an educational evaluation, visualization and content generation system 100 is provided. Here, one or more computers configured to execute code (e.g. an evaluation server 102). In a particular implementation, the evaluation server 102 includes one or more suitably configured processors having a memory and configured to execute code stored therein. The evaluation server 102 is configured to access, from one or more local or remote data storage repositories, a collection of stored information material or content. For example, as discussed herein, the evaluation server 102 is configured to access student assessments and other data relating to the educational assessments, professional activities, and personal metrics of present and former students.

The evaluation server 102 is configured to access information material and content from a remote database 108a. In another implementation, the evaluation server 102 is configured to access data from one or more databases. For instance, database 108a is a student assessment database for a specific educational institution, while database 108b is a database of professional evaluations. However, it is envisioned that more databases are connectable to the evaluation server 102 such that data sources for a plurality of institutions or organizations are accessible.

In a further implementation, the remote database 108a-b includes a database of individuals proficient in a given subject matter area and their associated educational evaluations, curriculum and other information.

The evaluation server 102 accesses content through a local area network, intranet, or internet. Such data exchanges can include one or more network interfaces, gateways, firewalls, security servers or other network hardware that permits or enables bidirectional data exchanges between the server 102 and databases 108a-b.

The evaluation server 102 is further configured to generate, upon evaluation of the accessed content, output datasets that are stored to local or remote data stores, such as database 108a and 108b. Additionally, the evaluation server 102 is configured to transmit or send the generated output datasets to one or more remote access devices, such as computers or processors 104.

The users of the remote access devices 104 are also able to access though the evaluation server 102, the content of the database(s) and other data associated with the output dataset or general data accessible or utilized by the evaluation server 102.

As used herein, “processor” or “computer” refers one or more electronic devices (e.g. semiconductor-based microcontrollers) configured with code in the form of software, to execute a given instruction set. For example, the evaluation server 102, database(s) 108 and remote access devices 104, include one or more processing or computing elements executing commercially available or custom operating system, e.g., MICROSOFT WINDOWS, APPLE OSX, UNIX or Linux based operating system implementations. In other implementations, evaluation server 102, database(s) 108 and remote access devices 104 each include custom or non-standard hardware, firmware or software configurations. For instance, the processor or computer can include one or more of a collection of micro-computing elements, computer-on-chip, field programmable gate arrays, graphical processing units, home entertainment consoles, media players, set-top boxes, prototyping devices or “hobby” computing elements. Such computing elements described are connected, directly or indirectly, to one or more memory storage devices (memories) to form a microcontroller structure. The memory is a persistent or non-persistent storage device that is operative to store an operating system for the processor in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules.

The computer memories may also comprise secondary computer memory, such as magnetic or optical disk drives or flash memory, that provide long term storage of data in a manner similar to the persistent memory device. In one or more embodiments, the memory of the processors provide for storage of application programs and data files when needed.

The processors or computers described are configured to execute code written in a standard, custom, proprietary or modified programming language such as a standard set, subset, superset or extended set of JavaScript, PHP, Ruby, Scala, Erlang, C, C++, Objective C, Swift, C#, Java, Assembly, Go, Python, Pearl, R, Visual Basic, Lisp, TensorFlow for ML, mClust, or Julia or any other object oriented, functional or other paradigm based programming language.

In one particular implementation, the evaluation server 102 is a server, computing cluster, cloud platform or computing array, configured to directly, or through a communication linkage, communicate and exchange data with the one or more remote access device 104.

As provided in the illustrated implementation, the evaluation server 102 is a computer server configured by code executing therein to accept electronic data queried from one of more remote data storage locations (e.g. databases 108a and 108b) and evaluate the queried or accessed data according to pre-determined or dynamic rules, logic, instructions or algorithms.

As used herein, the evaluation server 102 is configured with one or more remote or local data storage devices that store operating code, as well as user information. The evaluation server 102 is also configured to access remote resources such as third-party vendor information, user data, and communication data from third parties through implementation of code modules.

As the implementation of FIG. 1 illustrates, the evaluation server 102 is used to evaluate the content of the database(s) and, based on evaluation of the content, generate new content or reference to particular content. For example, the content stored in the databases are transformed into visualizations suitable for a lay user to assess or comprehend the interactions between and among the data.

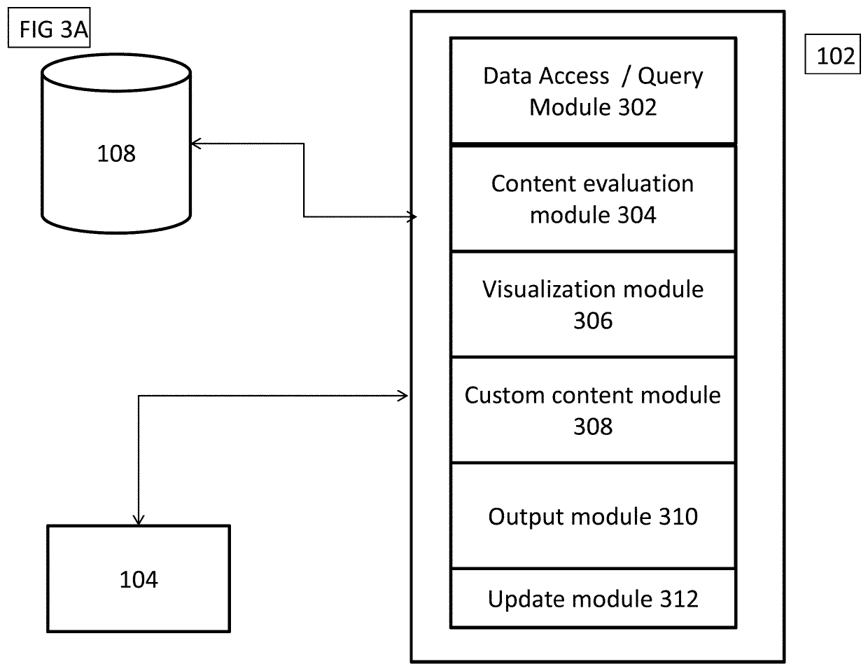

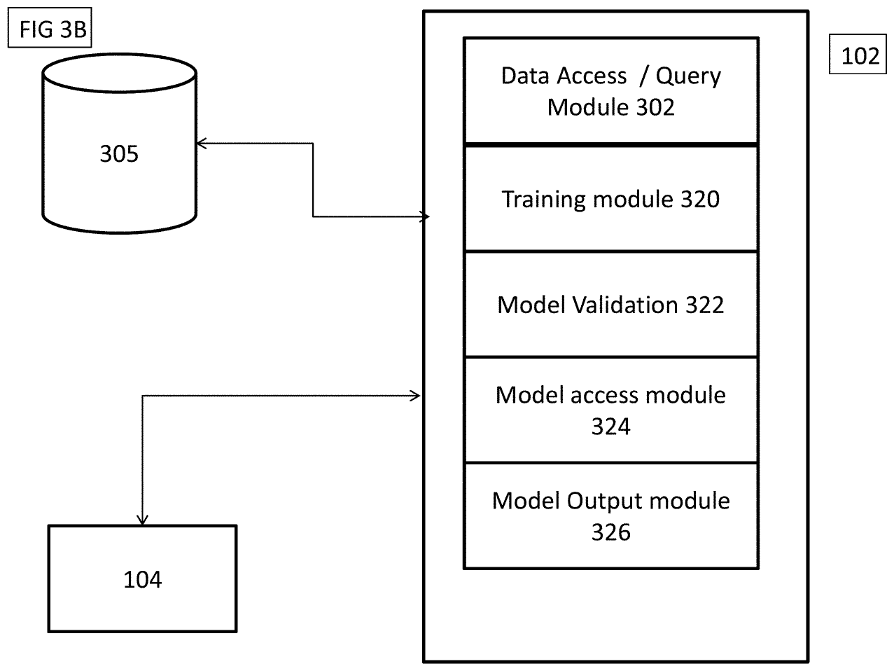

Referencing FIG. 3A, the content evaluation server 102 includes one or more software or hardware modules executed on a computing device or processor that collectively configures a processor(s) or computer(s) to implement the functionality of evaluating, visualizing and modifying the accessed data. In a particular implementation, the evaluation server 102 includes a single processor, multiple discrete processors, a multi-core processor, or other type of processor(s) known to those of skill in the art, configured by code to evaluate and mediate communications by and between remote devices.

With particular reference to FIG. 1, the content database 108a is one or more datastores 108 in communication with at least one processor of the evaluation server 102. The physical structure of the database(s) 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. The database 108 includes the necessary hardware and software to enable a processor local to the content evaluation server 102 to retrieve and store data within the database 108.

With more particular reference to FIG. 1, the remote access devices 104 are used to exchange data, such as electronic messages, data packages, streams or files, over a network to the evaluation server 102. In one implementation, the remote access device(s) 104 connects to the evaluation server 102 directly, such through an internal local network. Alternatively, remote access devices 104 connect to the evaluation server by first connecting to the Internet. As used herein, the remote device 104 is a general or single purpose computing device configured by hardware or software modules to connect to a network and receive data from the content evaluation server 102. For example, the remote access device 104 is a personal communication device (smartphone, tablet computer, etc.), configured by one or more code modules to exchange data with the content evaluation server 102. Remote access device 104 utilizes wired or wireless communication means, such as, but not limited to CDMA, GSM, Ethernet, Wi-Fi, Bluetooth, USB, serial communication protocols and hardware to connect to one or more access points, exchanges, network nodes or network routers.

In one implementation, remote access devices 104 are portable computing devices such as Apple iPad/iPhones®, Android® devices or other electronic devices executing a commercially available or custom operating system, e.g., MICROSOFT WINDOWS, APPLE OSX, UNIX or Linux based operating system implementations. In other implementations, remote access devices 104 are, or include, custom or non-standard hardware, firmware or software configurations. Here, the remote access devices 104 can communicate with the one or more remote networks using USB, digital input/output pins, eSATA, parallel ports, serial ports, FIREWIRE, Wi-Fi, Bluetooth, or other communication interfaces. In a particular configuration, the remote access devices 104 are also configured, through hardware and software modules, to connect to more remote servers, computers, peripherals or other hardware using standard or custom communication protocols and settings (e.g., TCP/IP, etc.) either through a local or remote network or through the Internet.

### Data Ingestion and Evaluation

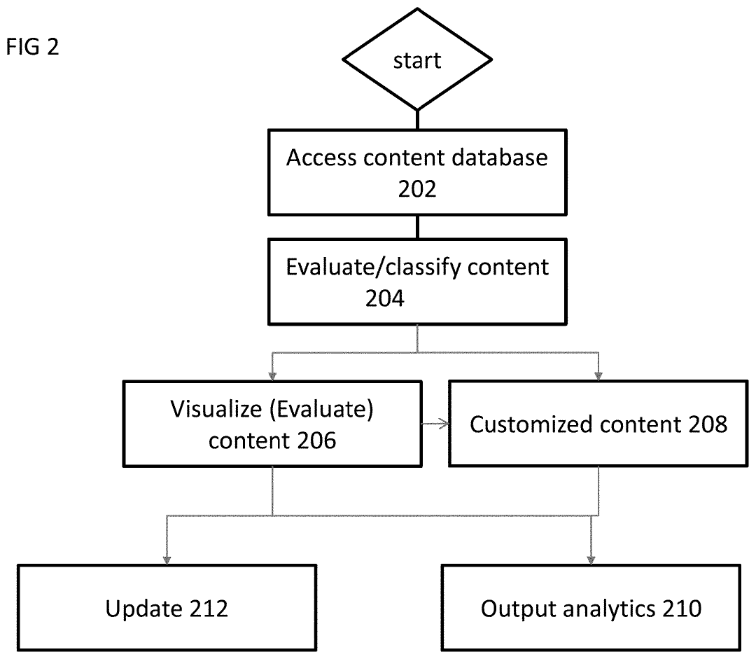

With particular reference to FIGS. 2-3A, the evaluation server 102 is configured, by one or more modules, to access the contents of the database(s). The accessed database 108a or 108b contains, in one implementation, a collection of documents, data sets, or evaluations.

For instance, the data stored in the databases 108 includes current and historical learner records or data sets and/or values relating thereto. For instance, a corpus of current and historical learner data accessed includes structured data such as test scores, Likert scale ordinal ratings, MCAT scores and the like. In a further implementation, the data stored in the database 108a or b includes current and historical unstructured datasets and/or values relating to learners. In one implementation, the unstructured dataset can include teacher evaluations, graduate questionnaire comments, medical student performance evaluations (MSPE's), or other documents that an institution would uses to match openings or opportunities with prospective candidates. In a further implementation, the data and checkpoint values provided in FIG. 9 are included in the database for past and present learners at a given medical education institution. For instance, attending a medical school results in the student achieving multiple key academic milestones and progressive learner ‘checkpoints.’ FIG. 9 details a non-exhaustive learner-derived data directory or dataset that includes: academics—exams scores, standardized national testing, academic leave(s); psychological profile—Myers-Briggs, situational judgment tests, non-academic leave(s); professionalism—ethical issues, illegal/high-risk behaviors; aptitudes—manual skills, clinical simulation tests (OSCE); and career planning—NMRP residency ‘match’ preferences, career advising activity and responses, financial status (student debt). Such data is, in one or more implementations, accessible by the evaluation server configured by the access module 302.

In yet a further implementation, Table 1 provides a collection of structured and unstructured data that is accessed stored in the databases accessed by one or more processors of the present system.

TABLE 1

| Data Category | Methods/Sources of Data | Sample variables |
|---|---|---|
| Learner | Medical school application | Age, Gender, Race, |
| demographics | Surveys/questionnaires | Socioeconomic Status |
| Admissions | Medical school application | Exam Scores, Grades, |
| Criteria | Multiple Mini-interviews | Transcripts, Prior |
| | (MMI) | experiences, MMI Scores |
| Performance | Registrar | Course grades, Scores on |
| in Medical | Learning Management | in-house examinations, |
| School | System | Competency-Based assessments |
| | Clinical Skills | of performance in clerkships, |
| | Center | Patient and procedural logs, |
| | | Standardized Patient (SP) |
| | | Exams scores, Objective |
| | | Structured Clinical |
| | | Examinations (OSCEs), |
| | | Comprehensive Clinical |
| | | Assessments (CCA) |
| Extra- | Student Affairs records | Volunteer experience, |
| curricular/ | Office of Undergraduate | Service Learning activities, |
| electives | Medical Education records | Involvement in research |
| National | USMLE Step Exams | Medical knowledge, |
| standardized | NBME Subject Exams | Clinical application, |
| examinations | | Core clinical skills |

Additionally, data that comprises some measure of structured data and unstructured data can also be stored and made accessible. For example, the data types provided in Table 2 are also accessible to the processor described herein.

TABLE 2

Characteristic/Data Element
Age of Matriculation
Gender Identification
Race
URM
Socioeconomic Status
Zip/Postal Code
Active Duty Military/Reserve
Veteran
Undergraduate Degree
Graduate Degree(s)
Pre-MD Debt
Parental Income
Bursary/Scholarship
Post-MD Debt
Total Undergraduate GPA
Undergraduate Science GPA
Total MCAT (Old; Raw; % ile)
MCAT Part 1
MCAT Part 2
MCAT Part 3
MCAT (New; Raw; % ile)
BBFL
CPBS
PSBB
CARS
CASPer Score(s)
Grades (letter, number):
MS-1
MS-2
MS-3
MS-4
CCA-1
CCA-2
CCA-3
USMLE Step 1
USMLE Step 2
USMLE Step 2 CS
USMLE Step 3
Graduating degree(s):
MD Degree only
MD/PhD Degree
Other Dual Degree
Years to Graduation (4, 5, 6)
Student Research Involvement
Added Qualifications
Selective Choice
Elective Choices - MS-3
Elective Choices - MS-4
Sub-I choice
Medical School Service Project
Job during Medical School
Residency 1st Choice
Residency 2nd Choice
Residency 3rd Choice
NRMP Match 1st Round
Non-NRMP Specialty Match
Military Match
Primary Care Residency
AOA
Gold Humanism Award
Other awards

Additionally, knowledge evaluation datasets (questions and answers on particular subjects), transcripts of lectures or public demonstrations and the like can also be stored and accessed from the databases 108. For example, the data in the databases may be generated or controlled by public organizations (i.e., AAMC, AFMC, etc.) and their member medical schools; private companies and their medical school data management clients; and/or data consortiums (i.e., ROMEO, DataCommons (AAMC+NBME) and Edifai of multiple medical schools. Here, such data aggregated or generated by the aforementioned organizations can be accessed, ingested or parsed by a suitably configured processor of the evaluation server.

In a further particular implementation, the database 108(a-b) represent public repositories or “open access” databases that contain information and data relevant herein. For example, one or more public databases 108 are repositories of data freely accessible to the public with minimal or no commercial fee, and/or where individual learners possess ownership rights of data pertaining to them.

It will be appreciated that the databases described can contain, generally, any data that is, or can be used, to assess the performance of a student (both in the near and long terms). For example, data amassed or generated by an institution (e.g. tuition records, work study applications, research grants, finical aid etc.) are in one implementation, included in the database 108. It will be understood that most professional schools possess extensive structured and unstructured data regarding multiple aspects of educational programming, student attributes and academic progress from multiple internal sources. Such data is usually stored in a number of working databases of various sizes and spreadsheet formats (Microsoft Excel, Google Sheets, etc.) that are accessible by the evaluation server 102. Furthermore, centralized public and private databanks also aggregate data elements submitted by member schools, affiliates and/or clients into separate function-specific data bins & buckets (AAMC Student Record System/SRS, AAMC Graduate Questionnaire/GQ, U.S. Medical Licensing Examination/USMLE affiliated with National Board of Medical Examiners, American Medical Student Association/AMSA, etc.). It is envisioned that all such datasets can be accessed and evaluated according to the systems described herein.

In one or more implementations, one or more processors of the evaluation server 102 is configured to execute a query on one or more databases 108(a-b) to retrieve data or a subset of data stored therein. In one implementation, an access or query module 302 configures the evaluation server 102 to access a particular dataset (e.g. all non-currently enrolled students) stored in the database 108a-b. For instance, the access or query module 302 allows a user to select one or more data values, types or sets of information stored in the database 108a-b. Alternatively, the processor 102 is configured by one or more sub modules of the access or query module 202 to automatically query the databases at regular time intervals.

Alternatively, the access or query module 202 configures the evaluation server 102 to access data from the database 108a-b based on user input or other signals or data generated locally or remote to the system. For example, where the database contains assessment data (e.g. standardized tests or report cards) the processor 102 is configured to query the database based on academic semesters or periods.

In a further implementation, the access and query module 202 configures a processor of the evaluation server 102 to integrate school-based (internal) and/or central repository (external) data into a single accessible data warehouse or source. For example, the access module 302 configures a processor of the evaluation server 102 to retrieve data from different databases and store the retrieved data in a single accessible database available to the evaluation server 102. It will be appreciated that pooling disparate types of structured and unstructured data from multiple sources offers scaling and storage benefits. For instance, by pooling data acquired, the system has lower bandwidth and access requirements than a system that continuously queries various databases. As a result, finite computing resources can be dedicated to evaluating the data and generating derived outputs. As an additional consideration, continuous access to disparate databases increases the opportunity and possibility of malicious or inadvertent data breaches. For example, learners (i.e. students), may under particular data regimes, have some ownership in their own personal educational information (PEI). Likewise, institutions place a premium of the security and confidentiality of their participation in multicenter research projects involving large data sets or so called big data. Thus, limiting the access of the disparate databases helps to ensure that the data accessed is not lost, stolen or misused.

In one or more configurations, the evaluation processor 102 is configured filter queries based on the security level of the underlying data. For example, data that is not anonymized or for which permission is not explicitly granted, is not returned in the query or search. The data stored in the database 108a-b, can, in one implementation, include a flag or identifier indicating the security level of the data. For instance, a low level of data security might be applied to information that has been de-identified, anonymous, or where public use and disclosure has been provided.

In one or more implementations, queried data can is filtered, prior to ingestion or evaluation by the systems described. In one implementation, the data is first filtered based one or more veracity metrics. Here, data veracity refers to data that has be stored or submitted directly by the learner or via intermediaries such as the professional education institution (with or without identifiable metadata); as collated by data repositories (scraped) or third-party data brokers and suppliers Likewise, data can be categorized based on the proprietary ownership rights (via data sharing and/or licensing agreements); privacy rules and policies (U.S. Federal Educational Rights and Privacy Act/FERPA); Cloud computing security policies or other policies influencing the data.

In one or more further implementations, the processor 102 is configured by the query or access module 202 to obtain data from one or more host data sources (central, institutional) using different query languages (i.e. SQL) from different relational database management systems (i.e., RDMS like MySQL). Here, SQL software is optimized for data storage and retrieval (Oracle, Microsoft SQL server, etc.). In a particular implementation, the evaluation server 102 is configured by the access module 302 to perform data extracts (and hyper format extracts) and save or store such extracted data to a local or remote database for additional processing. For example, the data accessed by a query initiated by access module 302 is transferred to large proprietary database for the purpose of data labeling and cleaning. Here, one or more submodules of the access module 202 configures the evaluation server 102 to format the data to assure that data extracted from diverse data sources are clearly understood and cohesive (i.e., ‘PSY-1’ may be coded as Physiology-1 in one school but may mean Psychology-1 in another database). For example, for each central data repository, the processor 102, configured by one or more submodules of the access module 302 to consult a look up table or conversion file that convert or applies internally cohesive labels for defining data and thereby reducing the labor-intensive data cleaning effort.

In a particular implementation of the concepts provided herein, one or more evaluation servers 102 are configured by the access module 302 to coordinate with sub-unit data stewards to extract data from legacy or non-interoperable systems. For example, though the use of a personal data lakes for students the evaluation server 102 is able to access or store relevant data from the registrar, Student Affairs, Admissions data repositories.

Once the data has been properly formatted, the proprietary database, or the contents thereof, can be pushed or transferred to a remote computing platform (e.g. Cloud platform such as but not limited to Google, IBM, Azure, AWS, etc.) that permits access to and utilization of secure cloud computing services (e.g. data storage, on-demand GPU compute power, applications, etc.).

In a particular implementation, the data received and processed by the database query module 302 is stored for future use in a separate local and secure database. For example, an encrypted database containing all the accessed data is provided.

Returning to FIG. 2, in response to a user query or remote data request, an access module 302 configures one or more processors of the evaluation server 102 to receive and parse the data from the database 108. As shown in step 202, the one or more processor of the evaluation server 102 receives data from the database. In one implementation, the data received from the database 108a-b is a collection unstructured and structured data from the database 108. However, the data received can represent one or more post-query transformations, such as filtering the data for features, access privileges (e.g. security), content, excerpts or formats.

In yet a further implementation, the database query module 302, or one or more additional modules, are used to transform the structured or unstructured data received from the database 108a-b. For example, the unstructured data may include personal assessments or other subjective statements relating to a learner. Here, one or more data transformations are used to transform such subjective data into numerical or vector data. Those possessing an ordinary level of skill in the requisite art will appreciate that unstructured data is difficult to utilize in ML applications because of the subjective nature of the documents. By converting subjective data into structured vector or numerical data, a wider array of data can be accessed and used by the systems so described. Thus, where conventional systems utilize only structured assessment data, the presently described systems and methods can make use of, and provide a solution to, a missing data problem. Furthermore, by converting or transforming unstructured data into structured data using a consistent method, non-identical pieces of unstructured data can be compared to one another using the systems and methods provided herein, thereby increasing the predictive accuracy of the overall system.

By way of non-limiting example, using one or more natural language processing applications, the evaluation server 102 is configured to parse the unstructured data (e.g. subjective assessment) and generate “tone” values (e.g. positive, negative, or mixed) associated therewith. These tone value or values (for instance the values could be degrees of confidence that the assessment fits into one of these categories) can then be utilized as structured data for easier comparison between learners within the predictive model. Alternately, word frequencies, text mining or other analytical techniques can be used to convert the unstructured data into a standardized and/or structured value(s).

Turning to step 204, the one or more processor of the evaluation server 102 is configured by an evaluation module 304 to evaluate the contents of data retrieved from the database. According to the evaluation outcome desired, one or more modules of the evaluation module 304 configure the one or more processor of the evaluation server 102 to generate a predictive model of the database contents according to a desired classification or outcome. For instance, the evaluation module 304 configures the data for each student (i.e. learner) and applies dataset wide analysis. By way of non-limiting implementation, at least one processor of the evaluation server 102 is configured to place the accessed data into dimensionality matrices (i.e. manifolds) that provide individual values or vectors for all the different categories of information accessed from the databases 108a-b. In an alternative, non-limiting implementation, one or more processors of the evaluation server 102 are configured to apply a principal component analysis (or another data analysis that reduces data dimensionality (i.e., reduces phenotypic heterogeneity) on the accessed dataset. Alternatively, the dataset is subject to one or more linear binary classifiers (or other supervised machine learning (ML)) approaches that optimizes model fit (via perceptron algorithm training) of input & output functions (e.g. so as to avoiding data over-fitting). Still further, one or more processors of the evaluation server 102 is configured by the evaluation module 304 to generate a model predictive of long term career success by evaluating the data using support vector regression (or other support vector machine (SVM)) classifiers that identify the best hyper-plane to separate data clusters (kernel machine analysis of data matrix similarities that permits SVM training).

In one non-limiting example, a curriculum optimization submodule of the evaluation module 304 is configured to access a training set of data from the database. Here, in one implementation, the training set of data comprises a collection of individuals (population) having verified or confirmed proficiency in one or more knowledge sectors or confirmed career or goal completion (e.g. passed a certification examination or evaluation). Data on the individuals can include indexes or arrays of the educational curriculum or methodology utilized by those individuals to obtain proficiency. Furthermore, one or more associated datasets can include psychological parameters or rankings for each member in the population. Using these datasets, one or more machine learning algorithms is implemented by the evaluation module 304 to generate a predictive model relative to the dataset. For example, the generated model is configured to output a score that is indicative that an individual learner will achieve a specified long term or short-term goal (e.g. graduate or obtain the desired career outcome).

In purely a non-limiting example, one or more processors of the evaluation server 102 are configured to identify suitable characteristics for applying ML analytics to create phenomaps (i.e., a virtual heat map) to gain insights about predictive model fit (or variance) for critical learner outcomes. Such described analytics are used, in one implementation, to generate a model predictive of academic milestones. For example, the model is used to generate predictions regarding USMLE scores (step exam scores at 50th, 75th, 90th percentiles), on-time promotions (absence for>1 semester); 4-year on-time graduation (exception: approved research project leave). Likewise, the generated model can be configured to provide predictive analysis relative to unstructured assessment data. For instance, the model generated by the processor 102 configured by the evaluation module 304 is configured to output data relative to a learner's resilience to adversity. As an example, the model generates a score or value relative to the learner's ability to overcome adversity based on activity participation (intramurals, student groups, service learning, volunteering); subjective well-being (burnout score); and/or absence of non-academic leave (exception: approved medical leave). In yet a further example, the model generated is capable of providing a predictive value indicative of the probably of a career outcome. Here, using the historical data provided in the datasets, the model generated according to evaluation module 304 is configured to output a value based on career planning goals. For example, the model evaluates self-assessed residency readiness (on 4th year GQ) values; residency NRMP Match success (1st-2nd program choice; absence of secondary ‘SOAP’ participation) values and other career values to generate an output value that correlates with a given career goal.

By way of non-limiting example, the modules described herein communicate and cooperate with one another such that a system is provided that evaluates a learner's probability of matriculating to a given institution of higher learning (e.g. a prestigious medical school). Those skilled in the art will appreciate that all applicants who apply to a given institution, desire to matriculate there. However, to increase long term career goals, the learner also need to evaluate not just the overall reputation of a given institution but also whether the institutions fit with their interests, strengths, career plans, etc. The systems, methods and computer products described herein utilize AI based systems to parse such structured data (e.g. school rankings) and unstructured data (e.g. personal learner fit) to identify the institution that presents the highest probability of achieving both the educational and career goals of the learner. For example, the present systems, methods and computer products are configured to stream or direct an entrepreneurial, high achieving student, to an institution known for nurturing “start-up” businesses, as opposed to a similarly ranked or prestigious institution that is more geared towards research.

By way of additional example, the evaluation server 102, configured by one or more evaluation modules 304, uses convolutional neural networks (CNN's) consisting of algorithms and high-speed computing elements (e.g. GPUs or field programmable gate arrays) to de-convolute massive datasets in order to predict outcomes, achieving progressively greater confidence through CNN ‘training.’

In an alternative implementation, the evaluation module 304 is configured to evaluate each knowledge source that provides or evaluates knowledge in a particular field where proficiency is sought. For example, the evaluation module 304 is configured to evaluate questions and answer sets as well as individual lectures or texts for the probability that such informational content is likely to convey or evaluate proficiency in the particular field. In a further example, the evaluation module 304 is used to classify and rank the source of proficiency in a cohort of individuals possessing and not possessing proficiency. For example, the evaluation module 304 identifies one or more potential or possible combinations of source knowledge and knowledge evaluation (e.g. exams plus homework vs quizzes and open learning) likely to result in individual proficiency. Additionally, the described evaluation module configures the processor to identify within evaluative sets (e.g. exams) which questions are highly correlated with proficiency in a given subject area. For example, a machine learning algorithm is implemented by one or more submodules to extract data from the data set or to classify the data of the dataset into one or more categories. In a particular implementation the machine learning classifier is implemented by one or more of a neural network, support vector machine, deep learning algorithm, linear or nonlinear regression algorithm, natural language processing system, Bayesian classifiers, Markov chain algorithms, deep learning algorithms or the like. In one non-limiting example, a machine learning classifier is used to classify academic testing questions and answer sets and determine based on prior historical data which question formats correlate highly with independent evidence of retained knowledge.

In a specific implementation, the evaluation module configures one or more processors described here to evaluate the structured or unstructured data using one or more dimensionality reduction techniques. As used herein, dimensionality reduction can be used to evaluate datasets having a large number of variables. For example, multivariable datasets defined by the educational and evaluative materials mentioned above can be reduced to a few principal variables in order to easily visualize the relationship between datasets (e.g. learners).

In one implementation, where the data accessed is related to evaluating subject matter experts and assessment materials, the query returned include the examination questions covering a certain topic, as well as information sources purporting to convey information about the same topic. In an alternative configuration, the query requests information independently classified as being representative of proficiency in a subject.

Once the model has been trained, as in step 204, using module 304, the data set can be visualized. For example, as shown in step 206, a processor configured with one or more visualization modules 306 generates a heat map or other visualization of the corpus of data as evaluated according to the generated model. Here, the processors 102 are configured to generate a virtual representation of the data set as evaluated according to the model. For instance, using an N-dimensional virtual array, each learner in the dataset (a portion or the entire corpus of learners) can be clustered according to an overall degree of similarity between input and output states. For example, the processor is configured to generate a visualization of the entire corpus of data such that similar learners are grouped according to an overall level of similarity. For instance, where particular learners did not attend the same institution, but had similar standardized test scores, adversity resiliency, and career outcomes, the visualization will group those learners together. In more specific detail, the visualization can include utilizing one or more neural networks to implement node or diffusion mapping algorithms to embed high-dimensional data sets into a Euclidean space (often low-dimensional). Thus, this machine learning based ‘pheno-mapping’ of millions of individual subject data points yields data clusters that predict outcomes not otherwise revealed to researchers using standard biostatical analyses. Such heat maps and analysis can be directly provided to one or more remote access devices 104. For instance, a user accessing the model generated in step 204 remotely can receive, as in step 210, a data file or data stream providing an interactive map showing clusters of learners meeting a desired or specific criterion.

In another implementation, the data visualization or mapping procedure utilizes self-organizing maps (also called self-organizing feature maps) to visualize the relationships between learners. Here, self-organizing maps generally refer to forms of computer generated neural networks trained using unsupervised learning methods. As a result, the self-organizing maps tend to produce low-dimensional (usually two-dimensional) discrete representations of an input space of a training sample. For example, using historical learner outcome data, the self-organizing map can cluster or group learners based on similarities to one another within a low-dimensional virtual space. This low dimension virtual representation is often referred to as a map. Here, such maps consist of nodes, associated with each node is a weight vector of the same dimension as the training input data vectors. The procedure for placing a data value in a particular node is to determine which node has a weight vector that is closest to the input vector. Using this technique, the coordinates of each data point in the Euclidean space are computed from the eigenvectors and eigenvalues (i.e., non-zero vector or values that, when multiplied by a matrix, generates multiples of the vector or value). Such mapping techniques are computationally inexpensive and are useful in reducing and displaying visually-complex multivariable datasets such as evaluation of educational materials and/or learner's assessment and outcome data.

Alternatively, principal component analysis, which is a statistical procedure that uses transformations (usually “orthogonal transformations”) to convert a set of possibly correlated variables into a set of linearly uncorrelated variables (called “principal components”), is also useful in reducing datasets for visualization. The number of principal components is often less than or equal to the number of original variables thereby reducing the dimensions of the data set for visualization.

In a particular implementation of the concepts provided herein, one or more evaluation servers 102 are configured by the evaluation module 304 to implement a machine learning (ML) pheno-mapping/cluster analysis to predict individual learner's academic performance, career aptitudes, and personal resilience. For example, the evaluation module 304 configures the evaluation server 102 to access datasets of students and to determine feature selection and correlations between selected features and outcomes. In one example, 2000 discrete data elements measuring>80 learner attributes from the point of medical school application to graduation including demographics, task performance data, opinions and standardized testing outcomes are provided to the configured evaluation server as test or training data to build a predictive model for student performance. The output the one or more predictive models generated by the evaluation module 304 can be visualized as heat maps, graphs, node diagrams or other ML based or other data visualizations.

In a further implementation, the evaluation server 102 is configured to use such heat maps or other visualization are used to implement personalized predictive information to assist in individual career planning, lifestyle management, and other key decisions during and after medical school for students. Here, such visualizations or “Edu-map”, provide deeper insight into how learner performance, aptitudes, and resilience are related in ways not otherwise revealed using standard statistical analysis.

Turning to step 208, the predictive model or classifier algorithms(s) generated step 204 are used to evaluate specific learners. For example, a corpus of data associated with a specific learner is applied to the model so as to generate predictive values for desired outcomes. By way of further non-limiting example, the generated predictive model evaluates new individuals and their associated datasets to predict if the individuals are likely to be proficient at a skill set or knowledge base given their present educational curriculum. Furthermore, the predictive models are used to evaluate one or more educational or teaching models to determine the probability that such a teaching model or evaluation regimen is more or less optimized to generate proficient individuals. For instance, the evaluation server 102 is configured to make recommendations for a student when the predictive model has a confidence of 50 to 60% for a prediction of individual learner performance, aptitudes and resilience. In a further arrangement, the confidence threshold for making a recommendation for a student is at least 60%. Such predictions and analysis would better inform learner's career decisions and program's advising interventions.

By way of further operative example, a user operating the remote access device 104 can access the generated model. The model here can be used to evaluate a specific learner's academic checkpoint progress and career planning. Here, the value(s) output by the model indicates a score relating to the likelihood the specific learner will meet the desired milestone or career goal. By way of non-limiting example, a user located at one or more remote computers 104 (such as a computer located or associated with professional education schools, post-graduate training programs and professional career advising/planning entities) allows the evaluation server 102 to access a specific educational dataset for a given learner.

Upon digesting or evaluating the individual learner's dataset, the custom content module 308 configures one or more processors to generate individualized predictive analytics relative to a learner's educational checkpoint/academic progress and on personal aptitude/professional career planning alignments are generated. In a further implementation, the analytics generated are transmitted to the user or the learner directly though the output module 310.

For example, the content module 308 configures one or more processors of the evaluation server 102 to generate new content based on an initial or initiating request or instruction. Here, the content generation module 308 configures the one or more processors of the evaluation server 102 to generate a proposed academic course or a specific skill gap in need of rectification for an individual learner. Where the model predicts a certain score for an individual learner, the content module 308 configures the evaluation server 102 to modify or augment one or more data values associated with the learner. For example, the content module 308 configures the evaluation server 102 change one or more data values in that learner's structured and unstructured data set. Upon augmenting the learner specific data set, the data set is evaluated again against the model. This process can proceed iteratively until the desired score is achieved. Once the desired score is achieved, the content module generates one or more data values indicating necessary data points (GPA, test score, work experience, etc.) needed to achieve the desired outcome.

In yet an alternative configuration, the content module 308 configures the evaluation server 102 to generate a set of questions and answers from a database of questions and answers. Here, the access to the model is used for validating approaches to student engagement and evaluation. As an example, each question and answer selected for inclusion into the set has a probability above a pre-determined threshold to be indicative of evaluating proficiency of a given knowledge area. In a further example, the content generation module 308 configures the processor of the evaluation server 102 to generate a curriculum based on predictive model. For example, based on the predictive model generated from individuals having proficiency in an area, individual curriculum types (open learning, Socratic, etc.) and curriculum content (e.g. texts, demonstrations, etc.) are selected for optimal inclusion and/or arrangement in a student's curriculum. For example, where additional biographic factors indicate that a current or prospective student may encounter psychological stress within the educational environment, a curriculum optimized for high proficiency, but low additional stress, is derived from the datasets using one or more predictive models.

By way of non-limiting example, the presently described systems and methods are utilized to and is directed to an integrated solution that provides user interface to one or more students that offers iterative NLP-based deconstruction of recently used standardized test questions (such as SAT, GRE, or USMLE). With the student's permission, the students' educational institution (e.g. law or medical school) uploads confidential student testing information, including past exam performance details. The student accesses, via a remote access device the presently described system and one or more (e.g. ten) questions specifically tailored to the student's studying needs.

For example, based on known data regarding upcoming testing dates, the student's past performance and additional information, studying materials, in addition to the one or more tests, become available every day leading up to the test or evaluation date. In one non-limiting implementation, the type, quantity and difficulty of the questions provided to the user are changed as a function of time relative to the date of the testing. For instance, where there the date of the test or examination is sufficiently distant in time (such as 6 months or greater) the system is configured to provide questions selected to give a proper foundation on the given subject. Where the deadline of the examination is fast approaching, the system is configured to send more focused questions that aim to represent anticipated questions that will be asked during the examination based on historical testing data. The system described herein provides the student with answers to the test questions, along with any relevant evidence from primary and/or secondary sources to support answers. The student's performance and test response psychometrics are computed and transformed by AI predictive analytics into a ‘Pre-test Confidence Index’. As the relevant test day approaches, the student's content mastery in prior areas of weakness is increased.

In one or more specific implementations, the remote computer 104 is located at a professional educational/training programs—via educational licensing agreements (discounted for comprehensive institutional data-sharing). For example, access to the evaluation server 102 can be used by educational administrators and student advisors to validate the school's career advisory programming. Such individuals and/or the related institutions can use the evaluation server 102, and the predicative model(s) provided thereby, to deploy continuous quality improvement (CQI) activities for an entire student body based on how that student body is classified or mapped in the virtualization. For example, where the educational institution is in jeopardy of lacking compliance with national professional school accreditation standards, the model can be utilized by the custom content module 308 to determine the broadest applicable change to the most students to bring the educational institution back into compliance. For example, the model can be used to determine a hyperplane that separates the majority of the students at a school lacking compliance with schools that meet their compliance requirements.

Additionally, one or more remote users can access the evaluation server 102 so as to provide private foundation experts and public jurisdiction planners with powerful longitudinal predictive analytics and insights to better inform policies & programs projected to address society's critical need for highly-trained professionals.

As shown with respect to step 210, the content generated by the content module 308 is output to one or more remote access devices 104 or stored in the database 108. In particular, the output module 310, or a submodule thereof, configures one or more processors of the evaluation server 102 to transmit data to the remote devices. For example, where the content generation module 308 generates an exam set, the exam set is sent or distributed to remote users, such as teaches, administrators or learners. Alternatively, where the remote access device 104 is a cloud based or remotely accessible application or server, the output model updates the content available on such a system.

In a further implementation, an update module 312 configures one or more processors of the evaluation server 102 to update the data used to generate the predictive models based on independently verified data as in step 212. For example, outcomes corresponding to the use of optimized testing sets are monitored or recorded. The monitored data is fed back into the datasets stored in one or more databases (such as but not limited to 108a and 108b) and used to further refine the predictive models. Such updating includes optimization of the educational assets and approaches. For example, educators are provided in near real-time updating of evidence-based teaching materials (i.e., lectures, on-line content, labs, workshops, etc.), in response to predictive models and evaluation of both materials and outcomes. Furthermore, by applying natural language processing [NLP] to disambiguate exam questions (and related answer choices), improved and directed testing and examination regimes are devised.

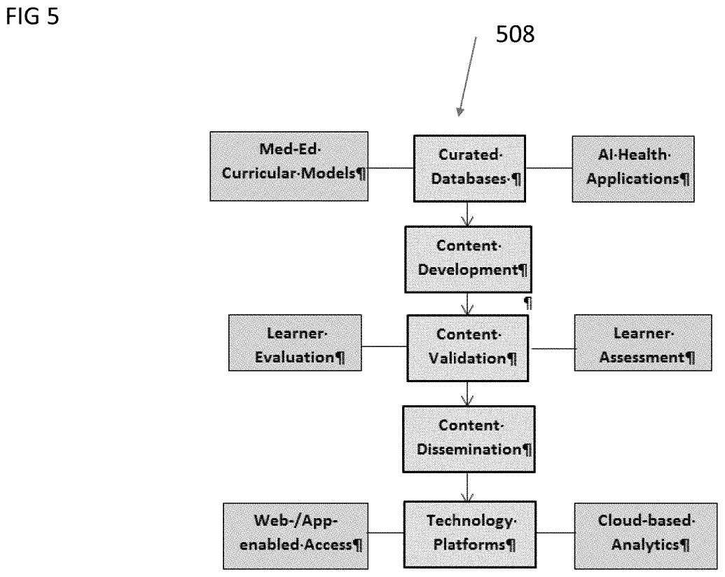

Such an approach is illustrated in the flow diagram of FIG. 5, where the curricular models (such as refined or evaluated assessment materials) are loaded or made accessible to a curated database. From this curated database content, such as learner materials or instruction materials can be curated or validated as new or revised content. For instance, updated examinations can be provided to the curated database 508. This examination or assessment content can be validated or reviewed for suitability having some predictive merit for a learner. For example, where a student's performance on a item of accessed content is determined to have a high correlation to a particular outcome, this content is deemed validated. Once validated, the content can be distributed to technology platforms for further dissemination to access by users.

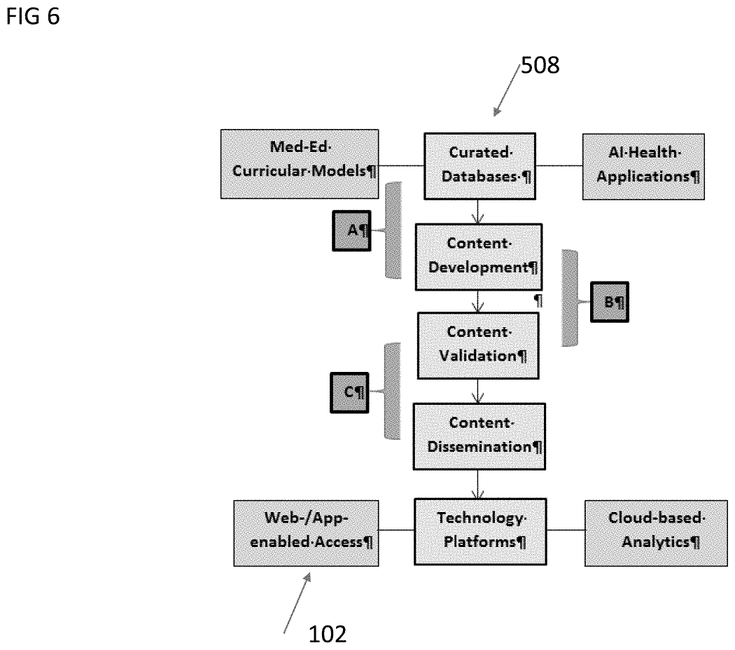

By way of particular further detail, and as shown in the flow diagram of FIG. 6, the curated databases (such as database 508) are used to store content (such as improved evaluation material) (in A). This developed content is validated using one or more analytical techniques (shown in process B). Once the developed content has been validated it is disseminated (process C) to technology platforms, such as the evaluative server or other analytic platforms. The process of content development can include a number of sub or intermediate (as shown in A) steps and processes that take into account the data sources provided in the curated database, such that content creation can, in some instances, be an iterative process. Likewise, based on the content validation step, the content might be revised or refashioned based on the validation analysis. For example, as shown in B, the process of content validation is also iterative, involving accessing the developed content and passing it to one or more content validators. This process might proceed iteratively until the content has been validated. As shown in C, the validated content is disseminated to users (i.e. individual learners or institutions). Like the preceding examples, this process can, in one implementation, be an iterative process.

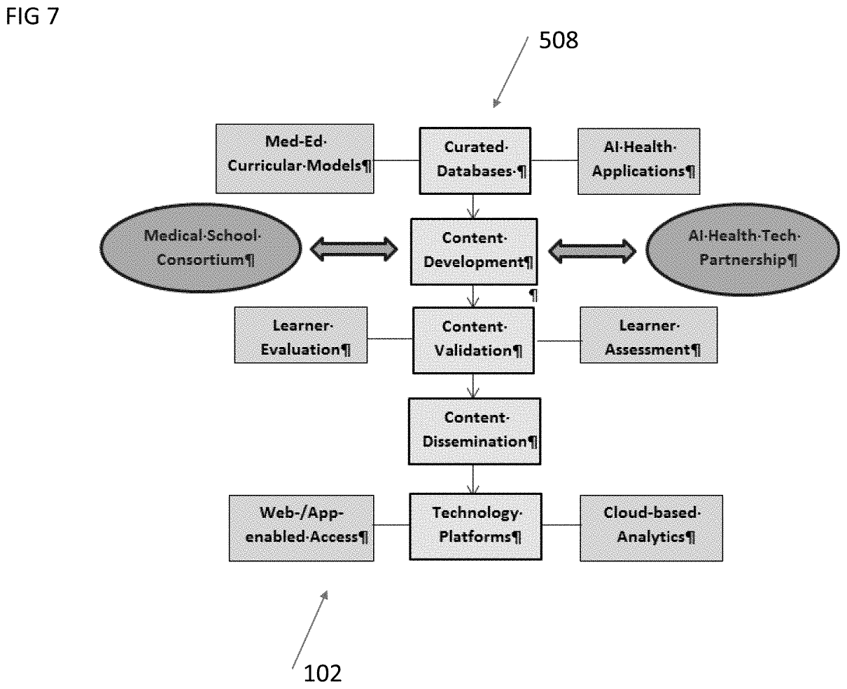

As shown in the flow diagram of FIG. 7, content flows into the curated databases through one or more external sources. For example, applications that track the health and wellbeing of students can provided information or evaluative content to the database that provides useful correlations between health or emotional states and student performance. Likewise, consortiums of learner institutions (such as medical schools) can provide additional information at the content development step. For instance, meta data relating to learner locations, demographics or other materials that might inform the correlations between the developed content and the determined outcome can be accessed and provided. The content received by the curated database can be used to further develop additional content.

Turning to FIG. 8, the content validation system can use information obtained from the use of the validated content to further validate or revise the validation of the content. For instance, where users use of the web application or analytic platform are monitored or evaluated while using or consuming content, the psychometric data obtained during that learner evaluation of content is used to further evaluate the content. By way of non-limiting example, where biometric data (e.g. heartbeat or blood pressure) of a learner is monitored while engaged in an assessment or evaluation of content, such biometric information is associated with the validated content. In one or more configurations, where the average biometric or psychometric data recorded is above or below a given or predetermined threshold when evaluating such content, the validated content is reevaluated for suitability. Likewise, learner assessment using the validated content is monitored by the analytic systems described herein. For instance, where the mean or average score on an assessment for a particular piece of content is outside the normal distribution of assessments, the content is reevaluated for difficulty or ambiguity.

In a particular implementation a system, method and approach is directed to the development of new or customized educational content in response to the application of one or more metrics correlated with improved learner outcome is provided. The particular implementation provided include details regarding user interaction with one or more implementations of a graphical user interface provided by the custom content generation system described herein. As shown in the flow details, the user interacts with the presently described approaches via a graphical user interface that responds to user input and provides updated information, notifications, and additional functionality.

In a further implementation of the approaches described herein, an evaluative training approach is provided. For instance, a system for training a model to evaluate and provide predictive guidance for a student or individual learner is contemplated herein. As shown in FIG. 3B, training a evaluative model includes accessing, such as though the access module 302, data from a training database 305. Here the training database is a collection of data values for a collection of students. For instance, the training database includes information for at least some of the structured data included in Table 2. By way of example only, the training database includes a collection of students (a training population) enrolled at one or more educational institutions. For each of these members of the training population, there is an associated training assessment dataset. This training assessment dataset can include the performance for the students on one or more of a collection of assessment measurements (such as scores on various tests). Likewise, the training database 305 can include at least one status identifier for each member of the training population. Such status identifiers might include an outcome for the member of the training population. For instance, the status identifier may include one or more values indicative of post educational employment, nature of employment, title, and the like. Likewise, the status identifier might include information about an area of focus for the student that occurred (i.e. surgical residency, ortho, etc.). In one or more instances, these status identifiers reflect the status attainment of the student after they had obtained the assessment measurements.

As shown with continued reference to FIG. 3B, a training module 320 configures a processor to develop, create or derive an expert system configured to determine correlations between the at least one performance metric of each member of the training population and the at least one status attained by each respective member of the training population. Such training module can be one or more of a collection of machine learning algorithms that are configured to evaluate the training database using supervised and/or unsupervised learning approaches and derive the correlations between at least the assessment data and the status outcomes. Further examples of the training module developing a trained or expert module can be found in Example 1.

Once one or models are generated, the models are validated using a model validation module 322. Here, a processor is configured by the model validation module 322 to access the generated models and apply the training dataset to the model in order to determine if the generated models produce results that are consistent with the training dataset in the training database 305. In one or more arrangements, the validation model 322 selects random data from the training dataset and applies that data to the models under validation. Based on the predictive accuracy of the models, such as above a preset threshold value, a model is flagged or characterized as validated.

Once a user, such an individual learner or institution accesses the analytic system provides, the user can access the validated models by configuring the processor with the model access module 324. The module access module selects an available expert module (that has been validated) that is configured to provide at least an assessment data relating to at a user. For instance, where the user supplies a collection of data to the analytic system (such as a subset of test scores) the model access module, without human intervention, selects the appropriate model that has been trained on some or all of the user supplied data.

Once the appropriate validated model is selected, the user data is evaluated by the processor configured by a model output module. Here, the model output module configures the processor to evaluate the user data with the model and provide an output based on the correlations made by the model. However, it should be appreciated that the output can be transformed or altered by subsequent processing prior to transmission to a user. For instance, where a module might provide a numerical likelihood for a given status outcome given user assessment data, the model output module 326 converts this numerical likelihood into one or more recommendations or alternative assessments for future action. By way of nonlimiting example, the model output module can provide a suggestion for improved performance or additional assistance if the user has indicated a preferred status attainment that is considered unlikely based on correlations with the assessment performance.

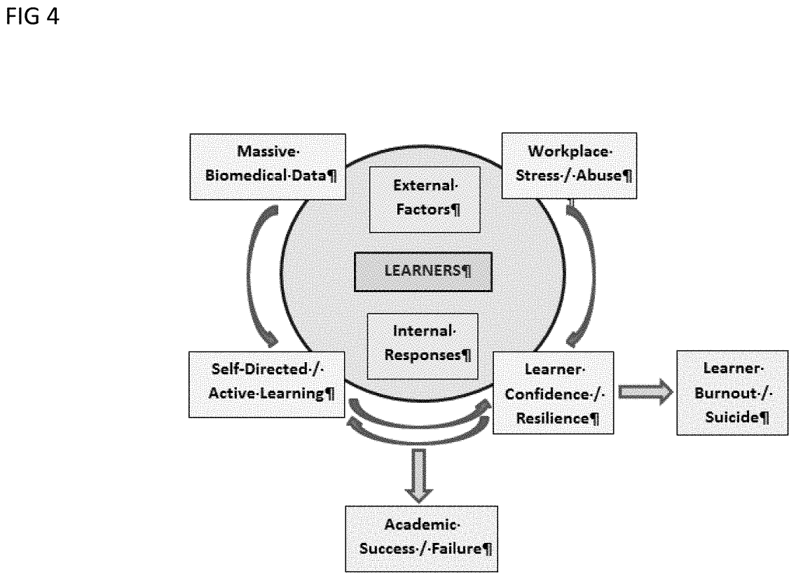

The approaches provided in FIGS. 4-9 relate to systems and methods that assist in validating the efficacy of active learning methodologies (i.e., self-directed learning, the “flipped classroom”, simulation, etc.). Additionally, learner evaluations, (e.g.—teaching materials & teachers; faculty member satisfaction & retention) Performance Assessments (e.g.—multi-institutional exam question banks; national standardized test results (United States Medical Licensing Exam [USMLE] data) and Student Outcomes (e.g.—career choice confidence; workplace psychological resilience; national educational experience surveys (AAMC Graduate Questionnaire [GQ] data) are all improved or optimized according to the systems and methods described herein.

### Additional Implementations

For instance, in a particular implementation, one or more machine learning or other artificially intelligent modules configure the evaluation server 102 to evaluate large medical student databases so as to create, manipulate or configure individual student profiles (Edu-maps) to predict individual or composite/global student outcomes (i.e., success, resilience, etc.) for a student population. In a further implementation, the level of confidence for predicting individual student outcomes via CNN training is enhanced by using curated databases populated by Edu-map program enrolled medical students and validated through a consortium of North American medical schools. In a further implementation, the evaluation server 102 is configured to use the described models and visualizations to implement personalized predictive information to assist in individual career planning, lifestyle management, and other key decisions during and after medical school for students. Likewise, medical schools (and other professional schools) have accessed to a computer implemented method that alleviates the struggle associated with student advising on career choice planning and life-work balance by providing active monitoring of likely candidates for early burnout, or those students having an increased likelihood of failure detection and intervention.

By way of further example, the systems and methods described herein are configured to carry out the compilation of comprehensive published literature and databases as evidence and create evidence profiles from disparate data sources (i.e., tests, evaluations, assessments, surveys, etc.). Such evidence profiles are assessed on evidence dimensions based on all sources' strength of evidence. The predictive models described are configured to learn from training data about the importance of an evidence dimension to an answer (i.e., positive or negative evidence) and combine evidence dimensions to improve outcome confidence through successive classifier phases (i.e., filter scores, algorithm rankings).

In one or more implementations, the training data is anonymized or encrypted prior to used to generate a predictive model. For example, the data are labeled, and have a combination of numeric and string values. In one or more configurations, the training data set is provided locally to the evaluation server. Alternatively, the training data is stored or accessible by one or more remote access devices or cloud storage systems.

In one or more implementations, multiple training sets, such as training data sourced from multiple educational institutions, are accessible to the suitably configured evaluation server 102. It should be appreciated that the training sets can be in the several gigabytes, as such, in or more implementations, the data is provided in portions, or chucks that are easily accessible and transferable.

The evaluation server 102 is configured to use SPSS and SAS or other package used for logical batched and non-batched statistical analysis for statistics and data analytics. In a further implementation, Tableau is utilized for reporting and data visualization. Expanded capabilities are required for doing ML-based predictive analytics, such as the mclust package in R for heat maps.

In one or more implementations, with particular reference to FIGS. 4-8, the present system and method provides optimized Educational Assets and Approaches. For instance, the systems and methods described provide improved outcomes in:

Teaching—by continuously updating evidence-based teaching materials (i.e., lectures, on-line content, labs, workshops, etc.)

Testing—by applying natural language processing [NLP] to disambiguate exam questions (and related answer choices)

Learning—by validating the efficacy of active learning methodologies (i.e., self-directed learning, the “flipped classroom”, simulation, etc.). The systems and methods also extract Real-world Data for Process Validation and Quality Improvement such as:

Learner Evaluations—teaching materials & teachers; faculty member satisfaction & retention

Performance Assessments—multi-institutional exam question banks; national standardized test results (United States Medical Licensing Exam [USMLE] data)

Student Outcomes—career choice confidence; workplace psychological resilience; national educational experience surveys (AAMC Graduate Questionnaire [GQ] data)

### Additional Information

In yet a further implementation, one or more processors are configured by code to generate from a collection of optimized format information data sources, one or more knowledge evaluative datasets (e.g. question and answer sets) for submission to exam takers or one or more educational assessment or evaluation compilers.

In still a further implementation, the system is configured to determine the content source(s) having the highest correlation to knowledge proficiency in a given user's desired proficiency area. Here, the systems and methods described are configured to evaluate various content sources that address the knowledge base to determine the optimal combination of knowledge base element to achieve proficiency in the area of interest.

### Modern Medical Education Pain Points

Medical schools and graduate medical education (GME) training programs sit squarely at the nexus of the digital technology explosion and a massive growth in scholarly peer-reviewed biomedical information (below). Undergraduate M.D. and GME programs are also the high-stakes homes of critical professional competency assessments leading to medical licensing and specialty credentialing.

The unprecedented acceleration of scientific discoveries and the increasing complexity of healthcare best practices now far exceed the capacity of medical students and other trainees to receive absorb and retain all relevant information. However, this body of published knowledge and other data repositories must be applied to optimize healthcare. This dichotomy is stressing medical schools & learners and is negatively impacting healthcare systems' ability to consistently deliver reliable, safe & high-quality care.

Innovations such as the electronic health record (EHR), miniaturized microprocessors in medical devices and telemedicine have lagged and/or been unevenly implemented, despite evidence that these technologies measurably enhance secure sharing of personal health information, quality of life and remote access to advanced healthcare. A proximate cause of this healthcare technology adoption lag is the failure of medical educators to better prepare learners to be early adopters before they enter the clinical workplace.

### Impact of Artificial Intelligence

The long-held potential of artificial intelligence (AI), whether classified as machine learning (ML) or deep learning (DL), is now being realized as a result of nearly unlimited Cloud-based computing capacity. Massive digital data sets, whether structured or unstructured, can now be screened using iterative algorithms (computer programmed Q&A) at processing speeds that far exceed human cognitive capacity.

For example, IBM Watson is a NLP AI problem-solving technology that has found numerous scientific and business applications, including life sciences, oncology/genomics, medical imaging, value-based healthcare, government programs and consumer health. The AI health business model primarily targets current users—scientists, doctors, Big Pharma, clinical trialists and healthcare executives—as the basis for platform adoption and product purchase.

Not yet considered, but potentially as important, are the future users of AI health applications—medical students, GME residents, and other healthcare trainees—learners who become early adopters of this technology, and who will become leaders in a rapidly changing system of data science-infused healthcare.

### Academic Medicine—AI Health Business Alignments

Medical schools have a responsibility to prepare medical students to be critical thinkers and early adopters of new technologies. AI's business imperative is to continuously grow market share by capturing the loyalty of future consumers for novel technology platforms. As such, Artificial Intelligence for Medical Education AI4MD represents a pipeline convergence for the healthcare professional workforce and the AI health customer base.

Medical student “users” graduate to eventually become healthcare “deciders”—physician practice leaders, Big Pharma executives, medical school deans, hospital CEO's and digital health entrepreneurs. However, there is currently no medical school curriculum addressing the applications of ML or DL to medical practice and healthcare. As such, AI4MD is a present-day opportunity to fundamentally affect future cohorts of “users” and “deciders”.

AI4MD also provides for academia-business partnership opportunities designed to prepare new doctors for a future where AI is intrinsically embedded in biomedical science, the practice of medicine and the delivery of healthcare. As such, AI4MD is a “win-win-win” for the partners—as learner resilience & physician workforce development strategies for medical schools, as a future business growth strategy for the AI health sector, and as a shared corporate social responsibility (CSR) initiative.

### Is Medical Learner Resilience In Critical Condition?

With particular reference to FIG. 4, in today's complex healthcare environment, learners experience significant personal stress. Clinical workplace abuse 1 and other stressors including the explosion of biomedical information have been correlated with increased rates of physician burnout and learner suicide. Once in medical practice, real world limitations exist to physicians staying current with the ever-expanding peer-reviewed medical literature.

Prompted by these serious concerns, national medical school accrediting bodies now require an increased emphasis on stress management counseling and self-reflection to help to improve learner resilience. However, there is no evidence that self-directed learning (SDL) or other active learning interventions reduce learner stress or physician burnout. Similarly, there is no peer-reviewed literature regarding the impact of active learning skills on medical student resilience.

A 2008 model of medical student well-being (above) provides a conceptual construct for addressing this challenge, but has produced little concrete action. In fact, the learner and physician resilience literature suggest that resilience training is ineffective.

But learner confidence is eroded by low resilience. The development and use of a structured AI health curriculum (AI4MD) by medical and healthcare professions schools, and the promise of greater future accessibility of ML/DL technology as a tool in medical practice, are interventions that could enhance learner resilience and confidence.

### How Medical Students Currently Learn

While all of these medical schools are accredited to confer the M.D. degree by a single body using the same performance standards, there is no standardized M.D. curriculum, no single definitive content source, no proscribed degree program duration, and no ideal teaching faculty composition. A universally shared “pain point” for medical schools (and students) is imparting (and learning) enormous amounts of salient biomedical and clinical knowledge within a limited time period—typically just four years.

Students entering medical school today have highly diverse undergraduate educational experiences. Problem-solving skills and inquisitiveness developed during a prior career or undergraduate degree can prove useful for solving medical cases. For example, to engineers the human body is an isolated system. Once any system is defined, engineers apply knowledge of that system to solve questions. This systems approach to thinking and problem-solving, honed during an undergraduate engineering education, challenges engineers turned medical students who are required to rote memorize endless facts.

The primary goal of a medical education remains information retention for future rapid recall. In order to compensate for recognized human memory limitations, medical educators have endeavored to teach medical students critical thinking skills. One impediment to teaching critical thinking in medical school (and subsequently during GME training and in medical practice) is the effective acquisition, interpretation and use of big data, in the face of a continuously evolving voluminous scientific literature.

As a result, the last decade has seen a major shift in the traditional medical education paradigm. Strongly encouraged by the M.D. program re-accreditation body (Liaison Committee on Medical Education), there has been a change from teacher-centered/subject-based teaching (didactic lectures) to the use of problem-based/student-centered approaches (active learning, student directed learning [SDL]). SDL is primarily intended to compensate for the human limitation to memorizing the rapidly expanding volume of scientific discoveries and evolving clinical care options.

However, the published SDL literature remains limited and somewhat inconsistent. Some medical school classes such as 2nd year gross anatomy laboratory are not well suited to a loosely-guided SDL approach. A study of 4th year medical students showed that no single or combined outcome measure or metric (i.e., class grades, standardized test scores) was reliably predicted by medical students' SDL aptitude. Surface learners (who memorize facts often motivated by fear of failure) actually outperform deep learners (who conceptualize meanings based on genuine interest) on lab-based exams.

Despite a paucity of empirical data demonstrating its educational efficacy, modern medical educators everywhere are preparing medical students to be self-directed learners. Most medical education curricula now feature SDL skill development. One medical school (University of Edinburgh) showed that a transition from primarily didactic instruction to faculty-supported SDL skill building improved anatomy exam scores from 2005 to 2010. A German medical school (Aachen University) employing the SDL curriculum approaches (i.e., e-learning, curriculum-guided self-study) demonstrated higher test scores in this cohort than in students learning via lectures and seminars.

Medical educators recognize that whether the M.D. curriculum covers topics ranging from anatomy to physiology to neuroscience to surgery, the interface between different learning styles and teaching methodologies impacts student satisfaction and academic achievement (content mastery, testing outcomes, etc.). No single teaching approach works for every student, or even for most students. As a consequence, learning needs also differ from student to student. Learning style is an individual's consistent way of perceiving, processing and retaining new information.

Learning style assessment tools (i.e., Kolb, VARK, ASSIST, etc.) show different student preferences according to gender and age; women and older students are more self-directed learners. Little empirical evidence exists to support any impact of learning styles on academic performance in tests and on objective structured clinical exams (OSCE's).

Medical school graduates are also expected to pursue lifelong learning (LL) activities to remain current with the biomedical literature and to retain their medical licenses throughout their careers. Ironically, the introduction of EHR technology (in the 1970's) as a clinical workplace tool has actually added stress for many providers.

### MedEd—AI Parallels and Caveats

Modern medical educators and M.D. program accreditors now promote active learning, which requires that students build upon rote memorization of existing knowledge foundations (surface learning). Students are taught to think hierarchically by asking good questions, and to independently identify, analyze and synthesize relevant facts into correct answers—this is self-directed learning. The SDL approach can be viewed as a healthy learning habit that evolves into a later career coping skill during subsequent GME training and in medical practice (lifelong learning, LL).

Contemporary theories of clinical reasoning involve a dual processing model consisting of a rapid intuitive component (type-1 or ‘heuristic’ thinking) and a slower, logical and analytical component (type-2 or ‘reflective’ thinking). Type-1 thinking maps well to generating a differential disease diagnoses, while type-2 thinking aligns best with information gathering (via history, physical exam, labs, etc.). Medical errors due to type-1 thinking failures (cognitive biases) are decreased by knowledge and experience. Type-2 errors increase when human working memory is limited, and are mitigated by the effective reorganization of knowledge (fact arrays).

Caveat: Medical education experts' current belief in the value of active learning (SDL, LL) to medical students (for personal resilience, academic performance, etc.) lacks empirical proof of efficacy.

AI programmers train computers to solve problems by asking well-informed questions, adding ever-expanding fact arrays, ranking multiple algorithm performance, then repeating in order to build confidence in the candidate answers—this is machine learning. When massive amounts of computational power and unambiguous data are available, AI software “neural networks” can mimic neuronal interactions between layers of the human brain's neo-cortex. Non-linear deep learning algorithms can recognize patterns in complex sounds, images, languages and other digital datasets.

In computing science terms, human dual processing thinking (types-1 and -2) are the equivalent of the interface between the computer processing unit (ultrafast CPU microprocessors) and operational algorithms (programmed for calculation, data processing, automated reasoning). Type-2 errors could be reduced through the use of highly effective AI health technologies that can memorize the entire peer-reviewed biomedical literature and/or reorganize complex facts (such as those in the EHR).

Caveat: AI health business proponents' belief in the value of ML/DL applications for helping doctors to make better medical decisions remains to be fully validated in typical clinical settings.

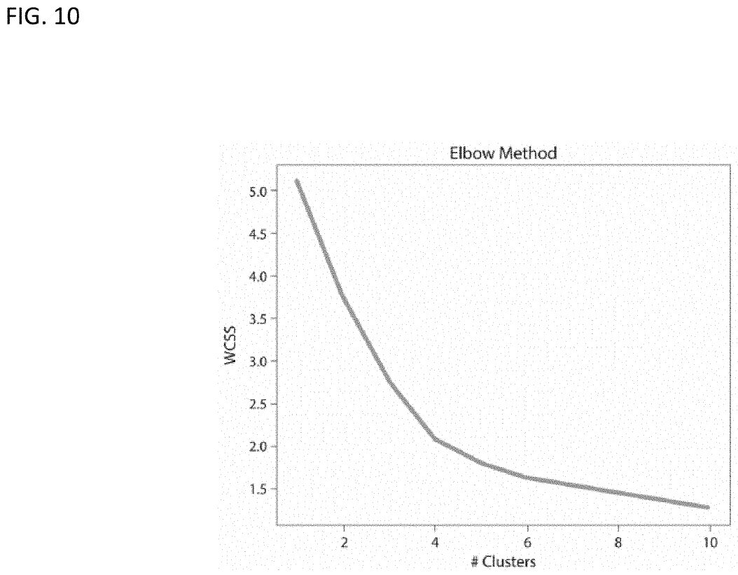

By way of definitions and overview, the table in FIG. 10, provides basic Machine Learning and Deep Learning Concepts that are applicable to the systems, methods and computer products described thought-out. With particular reference, the term Supervised ML—generally refers to functions (algorithms) that relate features to disease prediction; relaxing feature selection increases choices (decision trees, support vector machines, k-nearest neighbors method, etc.); neural networks with free parameters related to the function used for feature transformation (also predicts class based on features) until a good model is derived from the data; try different free parameters to determine similarity to known outputs (to estimate then minimize training error); challenge is to minimize training error (testing model complexity) without limiting generalizability (generalization ability to new data sets); requires 10,000's of training examples characterized by rich sets of informative features (challenge, because these are lacking in clinical medicine). Likewise, the term “Deep Learning (DL)” generally refers to the interplay of supervised and unsupervised ML, with stacked layers of increasingly higher order representations of objects (multiple data layers; CAP>2).

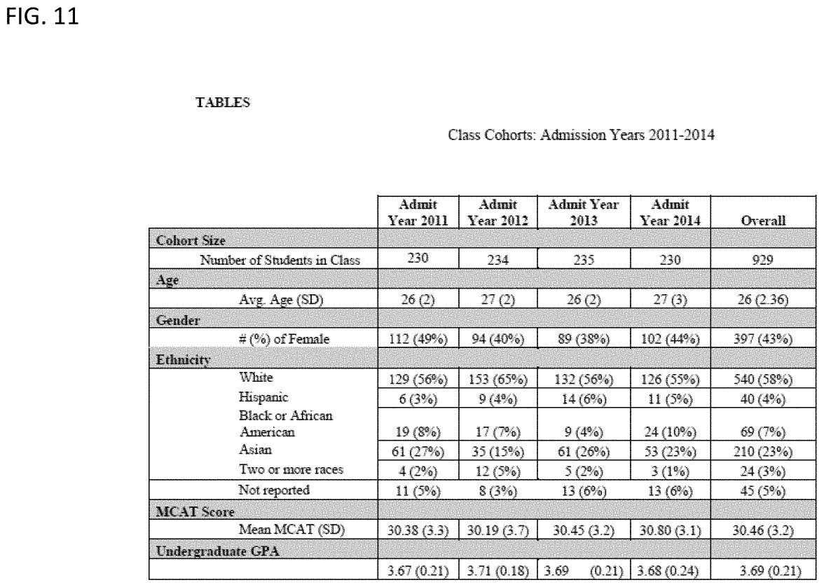

As used herein, and with specific reference to FIG. 11, there exists a correlation between certain categories of human educational models and machine learning techniques. Such correlations permit the greater overlap of concepts described herein.

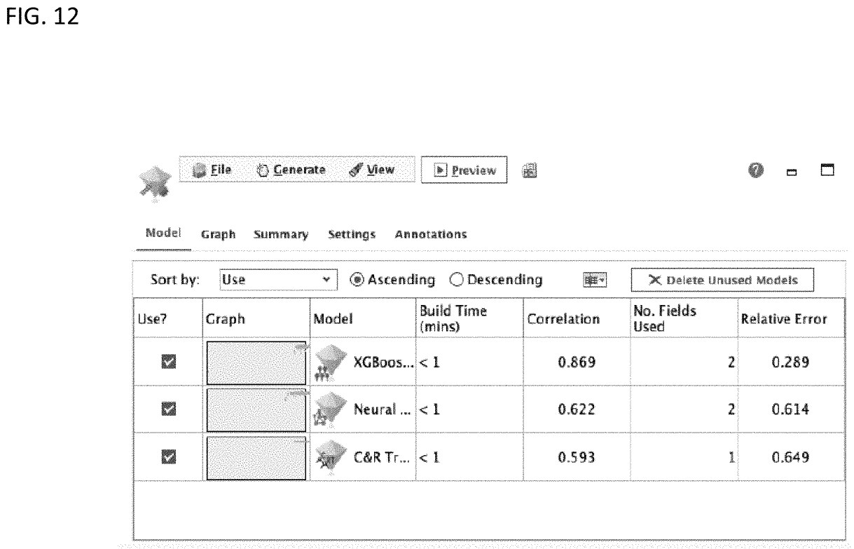

As further used herein, and with specific reference to FIG. 12, there exists certain task flow or workflow that allows the use machine learning techniques to improve human educational models. In turn, these educational models are used to implement predictions and judgement regarding student outcome and to select appropriate interventions for such students.

TABLE
Key Cognitive Health Curriculum Concepts

Artificial intelligence (AI)
Machine learning (ML)
Deep Learning (DL)
Evidence based medicine (EBM)
Systematic review
Strength of evidence
Big data (structured, unstructured)
Predictive analytics
Cloud based computing
Natural language processing (NLP)
Decision support
Application performance interface (API)
Disease management (DM)
Health maintenance
Precision Medicine (PM)
Population health
Electronic medical record (EMR)Personal health information (PHI)

### EXAMPLE 1

In one particular implementation, the student evaluation and assessment tool as described herein utilizes a predictive or analytical model. Such a predictive or analytical model is, in one arrangement, created using a data set obtained from curriculum evaluation & assessment activities and continuous quality improvement (CQI) processes. For example, the Liaison Committee for Medical Education (LCME) standards require medical school tracking of individual medical student performance for advancement and advising purposes, and of overall MD program outcomes for CQI and LCME accreditation purposes. Data from these collections are then used as training data for a predictive model that can be used to implement the evaluation platform provided herein. However, those having an ordinary level of skill in the requisite art will appreciate that data sources relating to student evaluation introduce various complexities. For example, schools and accreditation institutions produce datasets that include both real-time and longitudinal data components. These datasets can be continuously refreshed adding to their complexity. Furthermore, the rate of these time-series datasets, the diversity of data sources including vendor-learner application interfaces, and by the distribution of medical learners across varied clinical learning environments (i.e. campuses, healthcare systems, etc.) often involving non-interoperable information technology (IT) platforms, further present challenges to obtaining a standardized format of data that can be used to generate valid and useful analytical models.

To keep pace with these data-avid activities, as well as additional reporting requirements to national membership organizations and parent university systems, many medical schools have established dedicated data support units to manage related data capture, processing and storage functions. In one or more implementations, data support units and databases also can be remotely or directly accessible in order to facilitate access to one or more analytic platforms that are configured to access this stored evaluation data and process it in accordance with the analytical platform features described herein.

In order to capture data relevant to the analytical platform, and cognizant that the LCME requires current and trending data capture for CQI and for reporting of student performance and MD program effectiveness across all educational sites, these data sources and data-basing methodologies based thereupon are stored, in one implementation, in a central database accessible to the analytic platform. For instance, a user may have access to a unified dashboard that provides medical school administrators with a data platform for tracking information on admissions trends, curriculum effectiveness, student performance and faculty development. The content of this database can be localized for a particular institution (such as a medical school) or it can incorporate data relating to a plurality of different institutions.

In one or more further arrangements, the database administrators have physical access to the data and can directly control the configuration, management and security of the data. In one or more implementations, the databases are configured as commercially available databases. In alternative configurations, the databases are custom databases that are designed to store or arrange data relating to student outcomes and current status. In one or more configurations, the data stored in the database is staged from different source systems (such as, but not limited to, different educational institutions). The sourced data is then extracted, transformed and loaded (ETL) into tables optimized for reporting (i.e., data marts). In the present example, and for illustrative purposes only, Oracle Business Intelligence Suite Enterprise Edition (OBIEE), a product of Oracle Corporation of Redwood City, Calif., was used to create ad-hoc reports and dashboards. OBIEE was also used to handle the connectivity to the data warehouse and manage joins between different features and dimensions of the dataset in order to simplify queries, reporting and extraction of data for the end users.

In the foregoing example, data was obtained from a student information system (Banner), extracts from our performance evaluation system (one45), and standalone files such as NBME and USMLE Step exam scores. The data, in one or more implementations, is staged, transformed and loaded into tables optimized for reporting (Streamlining Curriculum Oversight and Program Evaluation, or SCOPE data warehouse—see below). These snapshots occur nightly so that each data cache is “stale” for <1 day.

Additional data sources were obtained from sources such ExamSoft and National Residency Match Program (NRMP) files. This robust data sourcing allows for routine CQI information tracking and reporting and serves as a platform for advanced AI analytics and predictive modeling using technologies such as ML algorithms. In order to achieve highly standardized data integrity, the presently described approach also includes one or more systems of record for each data source.

Subject matter experts inform decisions regarding the use cases for the data. Specifically, for the goal of predictive modeling of future academic performance, curriculum experts independently identified the data elements to be included in the database and the sources of the exam scores (i.e., USMLE, NBME, etc.). However, in one or more alternative configurations feature extraction algorithms were used to identify data elements that are predictive of the future performance. The decision as to whether to collect and record meta-data related to the exam score (e.g., first attempt vs. latest vs. passing scores) was prospectively undertaken in relationship to each use case. Expert stakeholders identified the medical learner and other medical education variables to be included in the data repository, and SCOPE specified how data sources would be linked to the data platform.

By way of reference to the present Example 1, a longitudinal learner data warehouse and academic administrative dashboard (SCOPE) was developed to contain the datasets that are to be used to train and validate the predictive model. Continuing with Example 1, the SCOPE database contains data on >4,000 medical learners dating from the Medical College of Georgia (MCG) from Class of 2008 to 2020. While historically analyzed using standard inferential statistical methods, SCOPE database developed supports the data extraction and database queries of more sophisticated software platforms for advanced discriminative AI analytics such as machine learning.

It will be appreciated that developing analytical models, especially those that have real-world impacts, requires that the data integrity be a paramount attribute of the training dataset. The developed SCOPE single data warehousing strategy offers significant benefits as compared to connecting to multiple systems in real time. Data warehousing also simplifies ML database query-building by presenting a single, straightforward relational schema. Moreover, it allows for better query task performance by offloading data from existing transactional systems and by requiring fewer compute-intensive interfaces among data tables.

In the present example, one or more processors were configured to carry out data pre-processing and feature engineering. Data pre-processing is an important step in ML analytics because the quality of the model is only as good as the quality of the inputted data. To improve the quality of knowledge representation in our datasets, we completed the following data pre-processing steps: 1) Cleaning: Since the data is being extracted from a data warehouse, the data has undergone normalization procedures. In one instance, the normalization process includes providing blanks for categorical data that was missing and “0” for numerical data that was missing. A leading zero was added if the zip code is a four-digit number. Such normalization processes allow for disparate data sets that might have different fields or content to be harmonized. 2) Generalize and group columns: Courses are often named differently in the system for the two four-year MD program campuses (in Augusta and Athens, Ga.), therefore year-1 and year-2 courses were renamed, generalized between the two campuses, and grouped by course content. In one particular implementation such generalization and group columns assignments can be conducted automatically. For example, a processor configured to access a look-up table of the relation between different courses. Here, such a look up table is able to match the same or substantially similar courses that have been named differently due to campus differences. This data harmonization step permits the data to be standardized across geographic locations. 3) Create new calculated fields: When needed, we created new attributes that captured the important information in a dataset much more efficiently than did the original attributes. For example, in cases where students are permitted to retake an exam, we used the highest grade achieved. 4) Convert categorical input variables to multiple binary input attributes called ‘dummy’ variables: Creating dummy variables is useful for techniques that do not support nominal input variables (i.e., k-means clustering algorithms), by requiring the change of nominal attributes to numerical ones. 5) Eliminate duplicate columns and data used to derive new fields: As appropriate, duplicate columns were removed. 6) Combine all data into a single table: Before starting any data analysis, we combined all the files into a single dataset using a join-by-subject identification number.

As part of the data preprocessing prior to the development of the analytical model, the harmonized data is visualized. In the present example an SPSS Modeler (a part of the Watson Studio, provided by International Business Machines of Armonk, N.Y.) was used to create a visual display of data and summary statistics that facilitated data wrangling of visible outliers, extreme and missing values. Heat mapping was also performed to better visualize some data representations. As a further step of conditioning the data for development of the analytical model, feature engineering of raw data from diverse sources (i.e., ‘omics and clinical data, learner evaluation and assessment data, etc.) was undertaken. Feature engineering involves data pre-processing techniques (i.e., cleaning, normalization, scaling, formatting, etc.) to assist ML algorithms in extracting predictive variables called features. Feature engineering can be automated to label data as being above or below a binary [0,1] threshold, or it can involve domain experts working closely with data scientists to build features for each data label (i.e. identifying new observations as cases or controls), then pairing these observations with associated features (i.e., age, gender, test results, etc.). Relevant features can then be more efficiently incorporated into either unsupervised or supervised ML models. Feature selection assures the inclusion of relevant data for ML predictive modeling. Feature selection techniques utilized include: a) univariate selection of ML algorithms for Python programming (i.e., using scikit-learn SelectKBest), b) feature importance using extra decision tree-based classifiers, and c) plotting of heat map matrices and cluster analysis dendrograms. Proper feature selection reduces model over-fitting to the training data, improves model accuracy, and shortens training time by reducing algorithm complexity.

### Data Pre-Analysis Preparation

In connection with the preparation of a predictive model for use in the evaluation platform described herein, computing system programs (such as ML algorithms) can be used to query many varied datasets. In Example 1, the processes employed for preparing the database for analytics involved three steps: Step 1: Data Extraction (E): securing data from internal source systems on a periodic basis (actively or passively) required that the data be extracted from the SCOPE data warehouse. Some data originated from internal data sources such Banner, One45, PeopleSoft, etc. Data was also extracted from external data sources such the AAMC Careers in Medicine, Capterra's ExamSoft, NRMP Match files, etc. Collectively, the dataset for this study contained comprehensive structured and unstructured information extracted from information on >4,000 students (i.e., demographics, admission and enrollment criteria, competencies, surveys, course evaluations, testing results, etc.) for all four years of medical school.

Once the data has been extracted, the data was then transformed. Data transformation requires connecting the data from diverse sources together and creating derived values. Collected raw data cannot be used directly for analysis as it must first be integrated and merged (i.e., transformed) into one comprehensive dataset that is appropriately pre-processed (including harmonization) and structured for analytic uses, such as data mining and/or ML based analysis. For the purposes of the study, the linked data was de-identified using an honest broker approach.

Next the transformed data was moved into a table data structure that is optimized for reporting the data in response to queries. These tables contain ‘facts’ (measurable information such as test scores, exam grades, and performance evaluations) and ‘dimensions’ (student descriptors used to organize and “slice” the data, such as gender, assigned campus, county of residence, undergraduate school attended, etc.). A fact and its related dimensions together comprise a “data mart” for specific subject areas of interest (i.e., admissions characteristics, academic equivalence by campus, declared career choices, etc.). Once this data foundation is established, applications and reports can be layered on without requiring the table creator to connect to multiple systems for resolving complex data relationships.

Following this ETL process, the learner datasets were ready to be used to develop an analytical model using commonly understood tools in the industry (i.e., SPSS Modeler, R, Python and other ML packages).

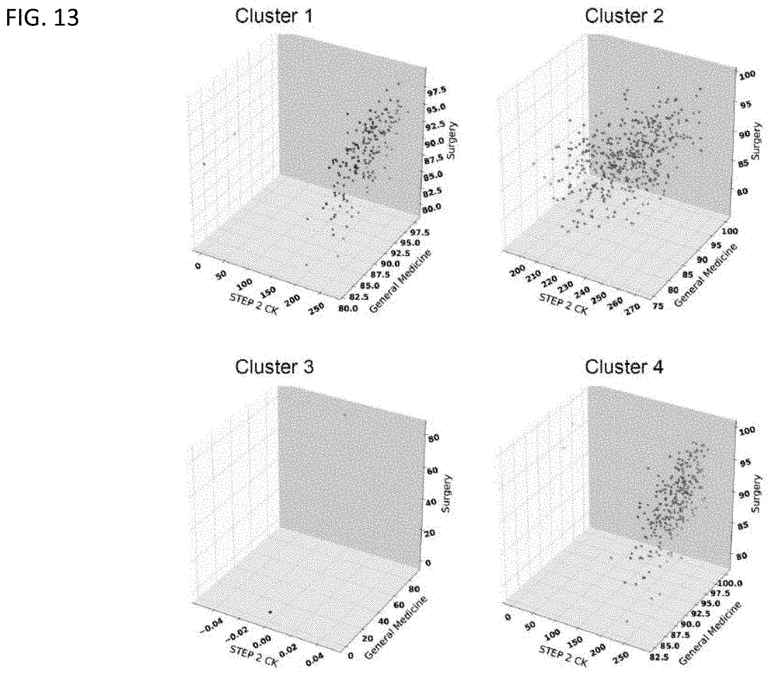

By way of further background on the steps in Example 1, there are two categories of ML algorithms—unsupervised and supervised (FIG. 13). In unsupervised learning, the machine receives input datasets and determines their relationship (if any) to other data patterns (i.e., clusters) and relationships(i.e., associations). Using this approach, there are no target or outcome variables to predict. In supervised learning, the machine is provided with a trained data set for algorithms to classify data patterns (i.e., features) that the computer will recognize again in new datasets. Unlike unsupervised learning, supervised ML algorithms specify a target and/or outcome variable which is to be predicted from a given set of input data (i.e., predictive modeling). The model is trained on the input data until it achieves a desired level of predictive accuracy for the target and/or outcome. Those skilled in the art appreciate that a wide array of open-access ML algorithms are available to optimize ML model outputs (i.e., predictors, classifiers). After evaluating these ML query-database communication and analysis options, we selected SPSS Modeler and Python for building the ML models. Both unsupervised and supervised learning approaches for data analysis.

### Unsupervised ML

The k-means clustering algorithm was used to classify unlabeled data items from the medical student population into different groups, based on some measure of mathematical similarity. A cluster is a collection of similar (to each other) items that are mathematically dissimilar from those in other data clusters. As such, a mathematical partition can be discriminated between data classes. Association rule-learning clustering ML algorithms uncover groupings that are unobvious using standard inferential statistical methodologies. As with other types of ML, raw data quality is the key determinant of cluster algorithm computing efficiency and efficacy. Thus, the prior data processing steps are important precursors to unsupervised ML approaches. Each of the various clustering algorithm approaches has its mathematical pros and cons. Whereas an initial set of weak base classifier predictions are combined and have their updated mathematical weighting (W) parameters adjusted through iteration to create a single stronger classifier, initial clusters can exert great influence on (and can bias) final clusters. For this reason, our cluster analyses were validated in multiple data runs.

To derive the optimal number of clusters from the dataset, the following three methodologies were employed to better organize the data for feature identification and/or classification:

Self-organizing maps (SOM)—SOMs are a type of artificial neural network (ANN) that learns to produce a low-dimensional (usually 2) discretized representation of the inputted training dataset. As such, it is primarily a data dimensionality reduction tool designed to simplify and visually represent (as maps) higher dimensional datasets.

Principle Component Analysis (PCA)—PCA is a data pre-processing technique that utilizes vectorial calculus (i.e., eigenvectors) to mathematically reduce the dimensionality of high dimensional (usually >3) data matrices such as digital images, genomics data, etc.

Elbow Method—selects the optimal number of clusters (k) by fitting the model with a range of values fork (usually from 1-10), and providing a representative graph of the percentage of variance that is explained by the within cluster sum of square clusters (WCSS) versus the total number of clusters. At some point, adding more clusters ceases to contribute useful information to the model, resulting in an “elbow” (the dataset had four clusters as shown in FIG. 10).

### Supervised ML

Next, we used a decision tree with enhanced ensemble algorithm boosting to determine the optimal predictive model. The auto-numeric node in SPSS modeler estimates and compares candidate predictive models for continuous numeric range outcomes using a number of different methods in a single modeling run. The auto-numeric node will apply different algorithms to the dataset and produce a comparison between the 3 top algorithms with the best prediction. In this case we used the open-source classifier, XGBoost (Python), which is a sequential ensemble decision tree algorithm method designed to “solve real-world scale problems using a minimal amount of resources”. The XGBoost method is extremely fast at producing results (<1 minute), effectively handling missing data, and using regulation to reduce model over-fitting. In SPSS Modeler, correlations reflect predictive accuracy of a ML model with respect to the training data. As shown in FIG. 11, XGBoost decision tree modeling produced the highest correlation with the lowest error rate (0.869 and 0.289, respectively) as compared to the classification and regression (C&R) Tree model and Neural Net nodes. (FIG. 12)

After defining our preferred ML algorithms, we determined algorithm performance using new (to the ML algorithms) datasets. The entire medical learner dataset was partitioned randomly with SPSS Modeler into 80% training dataset and 20% testing dataset. After training the predictive model on raw data, we then tested its robustness with new data in order to validate the model.

### Medical Learner Characteristics

Summary demographic and admissions academic data are presented in the table of FIG. 11 for the MCG classes admitted in the academic years (AY) 2011, 2012, 2013 and 2014.

### Unsupervised ML K-means Cluster Analysis

A cluster is a collection of similar (to each other) items that are mathematically dissimilar from those in other data clusters. There were four clusters identified by k-means algorithm analysis of a sample of 929 medical students whose data was warehoused in SCOPE between AY2011 and AY2018. The four clusters identified by the unsupervised ML analysis are partitioned as follows: Cluster 1=33.5% of the sample, Cluster 2=20.9%, Cluster 3=2.7%, and Cluster 4=42.9%. The four clusters identified by the unsupervised k-means algorithm are visually represented as a 3-dimensional rendering in FIG. 13. The points within each cluster represent individual de-identified medical students.

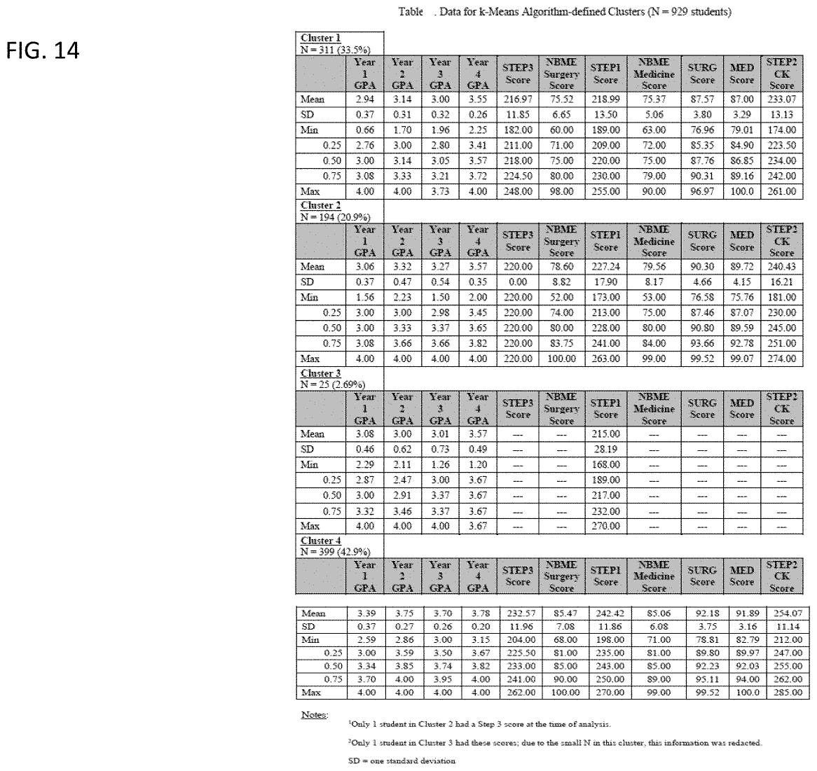

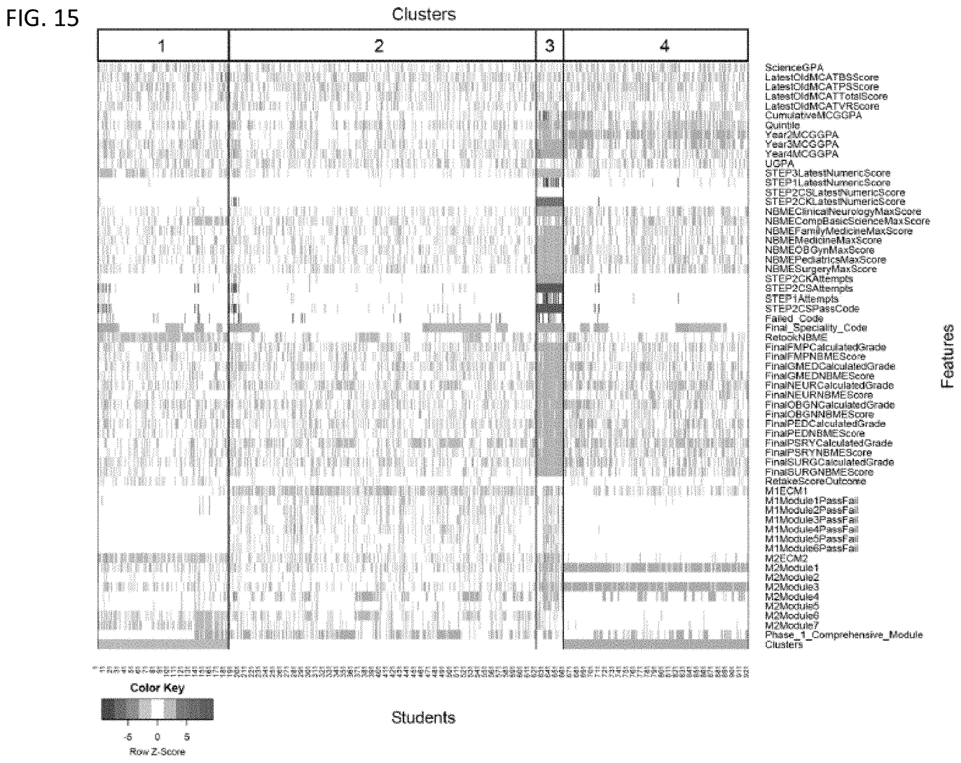

The Table of FIG. 14 contains a summary of the academic performance characteristics in each cluster as determined by using an unsupervised ML k-means algorithm. FIG. 15 is a heat map—a 2-dimensional representation of complex information—displaying the scaled values for each of the 62 academic performance features (in rows) in the 929 medical students (in columns). This data visualization approach to hierarchical clustering illustrates the overall heterogeneity of the entire medical student cohort, as well as the shared characteristics (i.e., learner ‘phenotypes’) of medical students within each of the four unique clusters.3

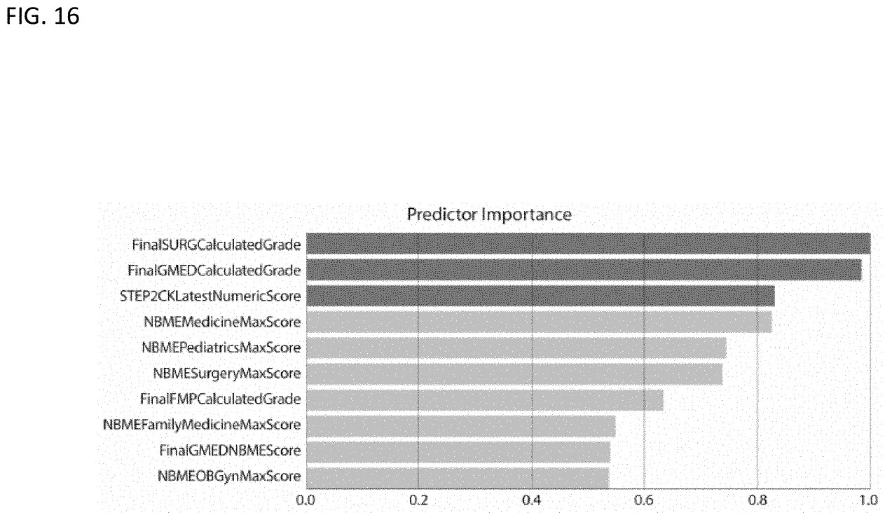

FIG. 16 illustrates the ranking of relative importance of various academic predictors to the formation of the four unique clusters identified by the unsupervised k-means ML algorithm. The top three cluster-forming predictors were final Surgery Clerkship Grade (SURG), final Medicine Clerkship Grade (GMED), and Step 2CK score.

### Supervised ML Predictive Modeling

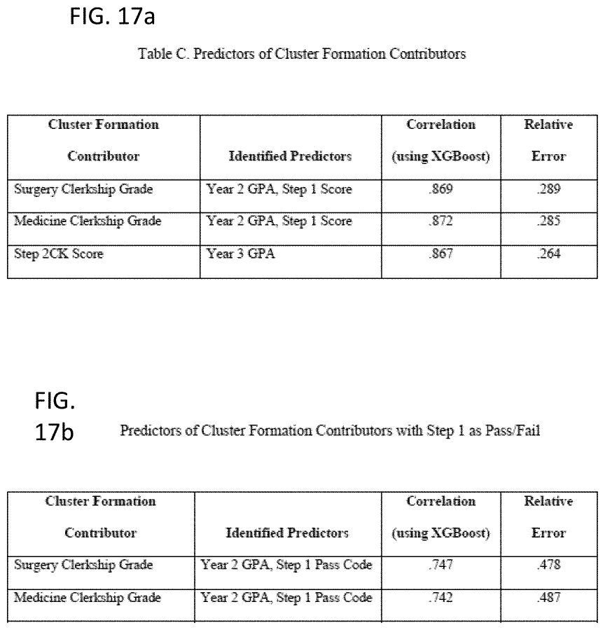

Supervised ML (XGBoost) was then applied to identify the best prior predictor or combination of predictors that were subsequently correlated with these key academic outcomes (FIGS. 17a and 17b). The correlations obtained using XGBoost (range=0.867-0.872) reflect our ML predictive model's high overall predictive accuracy with respect to the medical learner training data.

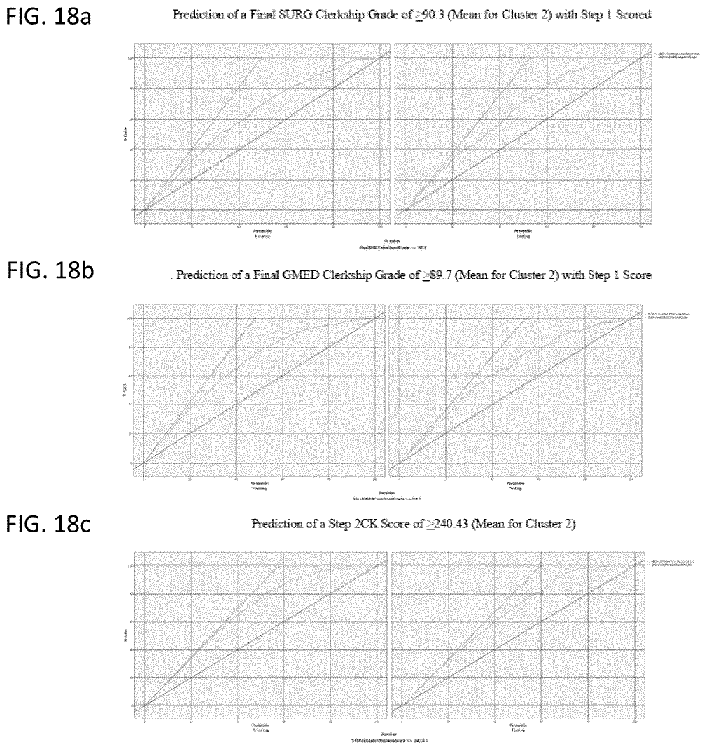

Gains charts provide a visual summary of the usefulness of information provided by statistical models (like ML) for predicting a categorical (binomial) or multi-categorical (multinomial) outcome variable.4 Gains charts (FIGS. 18a.-c.) were used to compare our ML predictive model against a baseline (the expected response for the entire sample if no model were used at all, also known as an “at-chance” model), and a perfect prediction model (a model that has no errors when making a prediction). For instance, the charts in FIGS. 18a-c shown the developed model's robustness (green line) for predicting future Surgery and Medicine clerkship grades and NBME Step 2CK test scores when the USMLE Step 1 predictor is a three-digit number.

### USMLE Step 1 Secondary Analysis

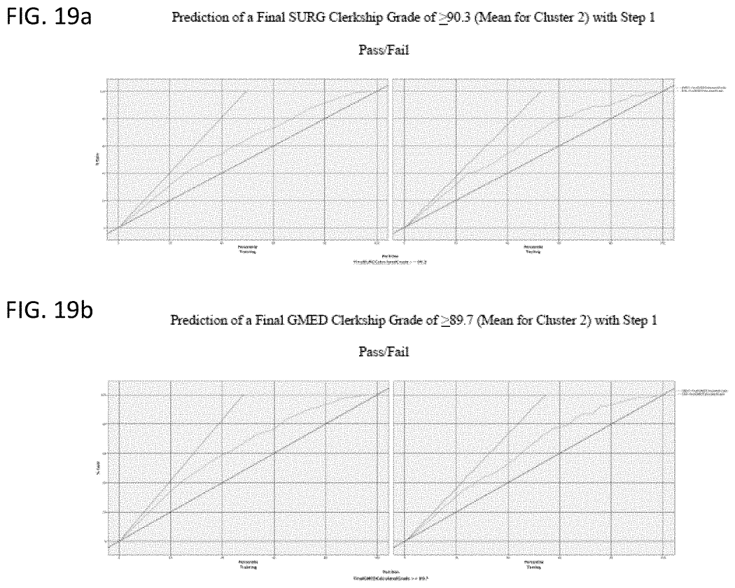

On Feb. 12, 2020, the National Board of Medical Examiners announced that “The USMLE program will change score reporting for Step 1 from a three-digit numeric score to reporting only a pass/fail outcome”, effective January, 2022. To examine the impact of that future change on our ML predictive model, we adjusted our model to only include USMLE Step 1 results as pass/fail code; the results of this secondary analysis are presented in Table D. A decline of correlation with other high-dimensional data matrix co-variables (i.e., the goodness-of-fit) associated with a categorical (pass/fail) versus continuous (three-digit numerical score) expression of USMLE Step 1 results is a predictable statistical outcome. The Gains charts (FIGS. 19a.-b.) illustrate that our ML model's predictive accuracy for average final SURG and GMED grades in Cluster 2 declined somewhat from perfect when Step 1 pass/fail coding was used but remained strong as compared to the baseline predictive model. The Gains charts show the model's robustness (green line) for predicting future Surgery and Medicine clerkship grades, under conditions when the USMLE Step 1 predictor was converted to pass/fail. This result allows for a comparison between different versions of an educational or skill assessment. For example, in the present implementation, decision to change a test from a numerical score to a pass/fail decision (as proposed by the NBME in February 2020, to become effective in January 2022) NBME is very interested in this big data-AI analytic approach to their current & future test scoring approaches (they may invest). This three-digit score has had a MAJOR influence on student Match success and related career decision (i.e., specialty choices).

### Choosing Proper Methodologies

The foregoing application provided one or more implementations of a student evaluation system that uses a pre-trained model to evaluate likely student outcomes. The analytical approaches provided herein are directed to the data science methodologies and ML applications needed to train a predictive model to evaluate an educational institution (i.e. a medical school) existing student data and classify students or other learners (such as medical students, law students or others) into unique clusters (with unsupervised learning) and to predictively model near-term academic outcomes (with supervised learning). It will be appreciated that the ML algorithms used herein are sets of unambiguous mathematical instructions (i.e., rules) that, when implemented in one or more processors (such as processor 102) can calculate a step-by-step solution to a complex problem and re-iterate that process on diverse datasets (i.e., learn). A wide array of ML algorithms are available to mathematically optimize model outputs (i.e., predictors, classifiers), and many such algorithms are readily available from open access sources. The choice of which ML algorithm to employ depends on the type of problem being addressed, the nature of the data, and the availability of computing resources. In this Example 1, the selected SPSS Modeler and Python-based ML algorithm choices are used due to availability, familiarity and are related to the robustness of the results obtained by requisite trial & error testing, should not be construed as limiting the concepts provided herein to those implementations of ML algorithm justified in the Methods section, which is not uncommon in ML analytics.

### Dataset Availability, Size and Quality

Generally, the more complex the AI model the more data is required. For most datasets with an adequate number of data elements and limited data dimensions, supervised ML classifiers and regressors—support vector machines (SVM), decision tree-based methods such as random forests (with/without gradient boosting ensembles), linear discriminant analysis (LDA), etc.—are capable of achieving good performance. Several examples from the clinical research literature confirm that standard ML algorithms accurately predict adverse clinical outcomes (i.e., hospital readmission, in-hospital mortality, cardiac events, etc.) within study cohorts ranging in size from 400 to 7,000 patients. In comparison, our study used an initial sample of ˜1,288 and a final sample of 929 medical students with ˜200 unique data elements per student (see Data Directory, appended).

By contrast, DL models require very large amounts of raw input data (>10,000 elements) to train artificial neural networks to efficiently recognize features and to achieve sufficiently high model performance. While these more complex unsupervised DL methods have great potential, they do not necessarily confer an advantage over standard ML algorithms. Very large clinical datasets (i.e., EMRs, administrative health databases, etc.) and high-speed parallel computing demanded by DL analytics have become increasingly available and practical. That said, their utility depends on the quality of the data in these large datasets, and DL models need not replace the use of ML classifiers and regressors on smaller, cleaner, tabular datasets such as those employed in this study.

Contextual Adaptability

We note that over time various datasets or features thereof can be migrated to different values. For example, the USMLE decided in February 2020 decision to change the three-digit Step 1 score to a binary score (pass/fail). The removal of three-digit numerical scores from Step 1 will impact medical students and medical schools and change the manner by which residency program directors pre-sort applicant suitability before the annual NRMP (the Match). The model constructed in this Example 1 showed that the top two cluster-forming contributors, final SURG grade and final GMED grade, were both highly predicted by the Step 1 score. When the Step 1 score is changed in the training dataset to a pass/fail coding, the model provides lower correlations using Step 1 pass/fail coding for the same medical student clusters.

The model provided in this Example 1 can be used to evaluate, in real-time medical student learner data. Such evaluation, built using larger and potentially less biased multi-institutional datasets could offer real-time insights on the academic positioning and performance trajectories of individual learners related to the in-cluster and near-cluster peers. For example, the analysis platform described herein, and incorporating the model trained in this Example 1, configures a processor to predictively model the career paths of individual medical learners. For instance, based on the output of the model, determinations about elective choices, research projects, service and other determinations made by the student can be pre-selected or recommended. Furthermore, the analytics platform may tag key personal success icons (i.e., empathy, manual dexterity, grit) and feed these data features into the analytic model. In turn the analytic platform is configured to evaluate the medical learner's information in real time, or near real time, and provide alerts along the medical learner educational journey. For instance, in one or more implementations, the model provided in Example 1 is configured to monitor the cluster that the learner is grouped into and determine when the learner has moved from a first cluster to a second cluster.

### EXAMPLE 2

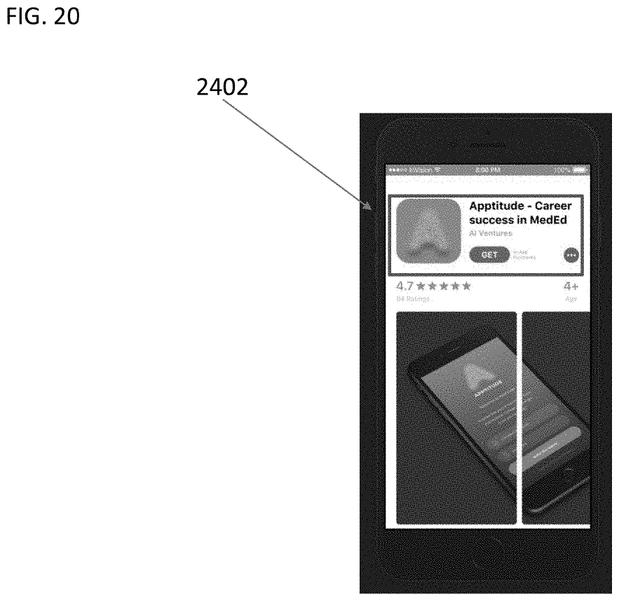

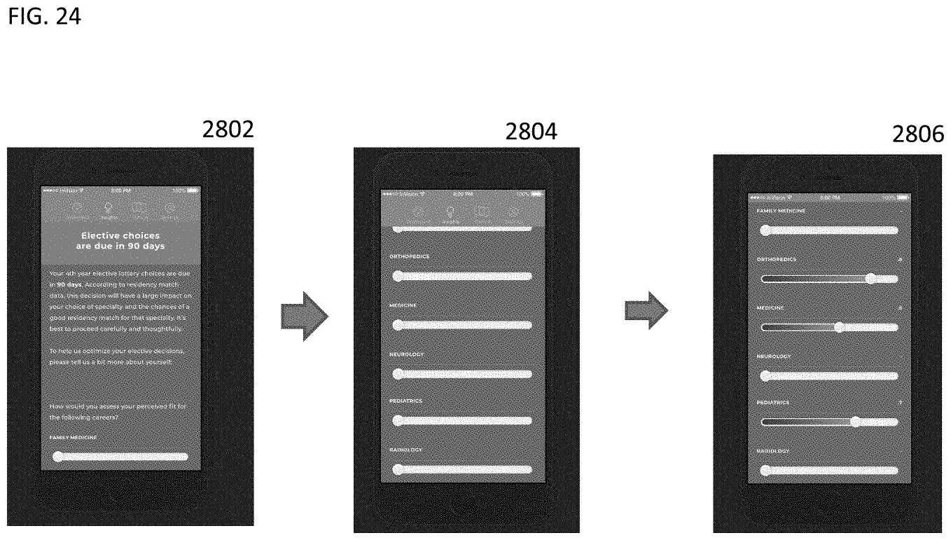

A further and particular implementation of the approaches described herein are provided as Example 2. As provided in more details with respect to FIGS. 20-31, in one implementation, a software application is configured to deliver enhanced information to learners (i.e. students) and administrators (assuming that proper security and permission protocols are implemented) using a real-time dynamic database coupled to advanced (AI) analytics. In a particular implementation, such capabilities are presented in connection with a mobile device (2402). For instance, in a particular implementation of the system, method and approaches for providing new or customized educational content in response to the application of one or more metrics correlated with improved learner outcomes predicted based on the machine learning or expert systems described herein.

In the particular implementation provided in FIGS. 20-31, a user interaction work flow is provided. For instance, Example 2 provides a software application operating on a mobile computing device that allows a user to access information and analysis of the user based on a user account. FIG. 20 provides one or more implementations, where a user whose data is stored, accessed or evaluated by the analytic approaches described herein can access or register for such a system. Such access, can, in various implementations include providing a user account sub-system (2502) that the user is able to provide access credentials to authenticate their user.

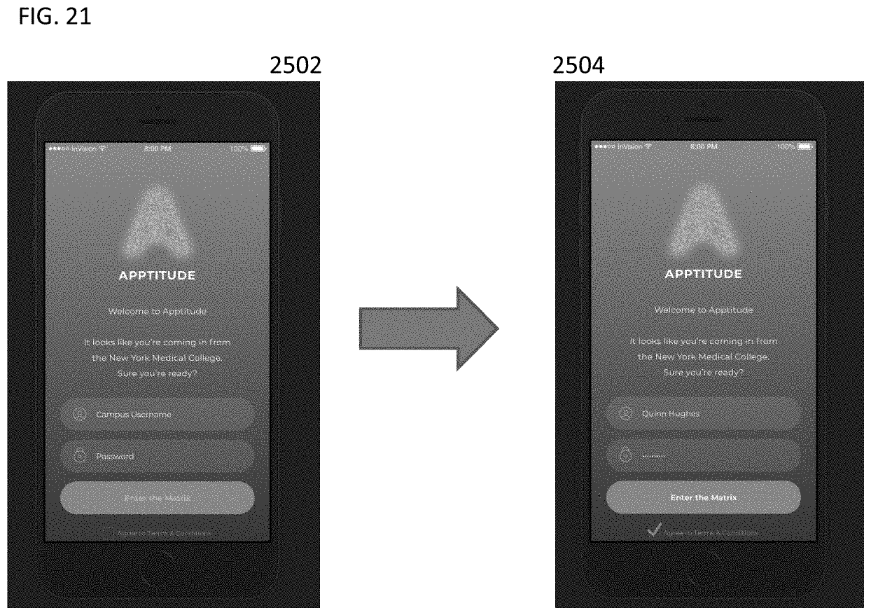

As shown in FIG. 21, an authenticated user is provided with a collection of data provided by the analytical systems described. Such information can be implemented a unique user “profile” (2602) that compares the user with other similarly situated users. For example, the user relationship to other users is depicted visually in one or more dynamically generated visual displays (2604). Such visual positioning information is based on the underling metrics (such as the clustering data of Example 1) developed by the analytic system provided herein. Such data can also be combined with other data sets (such as occupational data sets) (2606) to provide composite visual indicators of both the user's relative positioning as well as the career type representing those particular clusters of learners.

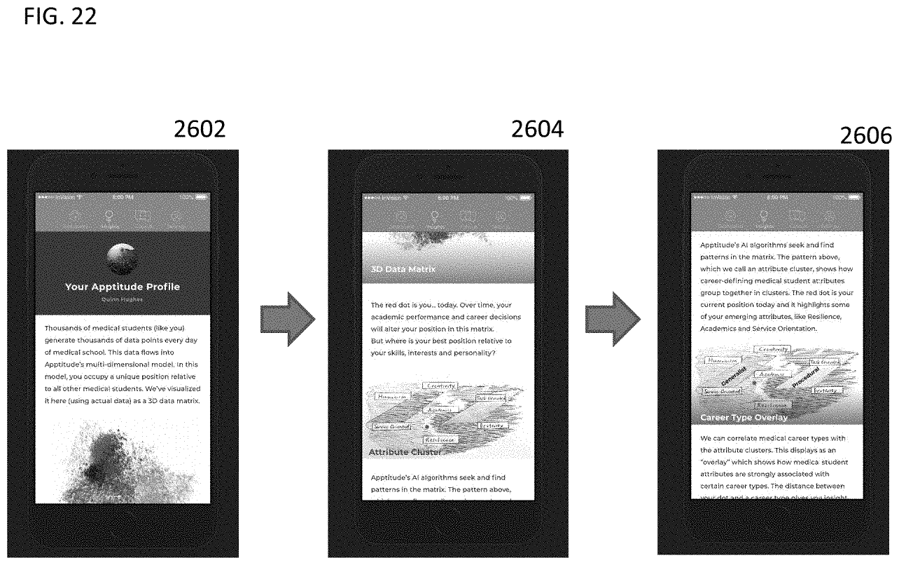

In another implementation, as shown in FIG. 22, the software is configured to provide the data in alternative formats, such as using numerical indicators or graphical elements (like line bars) (2702). Likewise, where the data used to generate the user interface include dates or times to decision points, the user interface is configured to dynamically update the time to a decision point Likewise, the user interface is configured to provide an element (as in 2704) that allows the user to access additional information about the dynamic data (such as a decision point date).

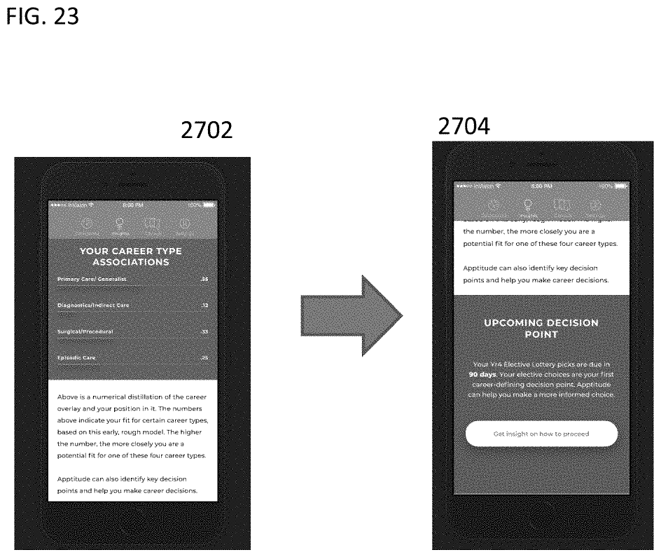

In one or more further implementations, shown in FIG. 23, the software is configured to receive user input data evaluating the user for a number of different criteria (2802). For example, the user is configured to provide information relative to the perceived career fit (2804). Based on the user's selections (as in 2806), the information provided is sent back to one or more servers (such as cloud server) for additional processing or evaluation.

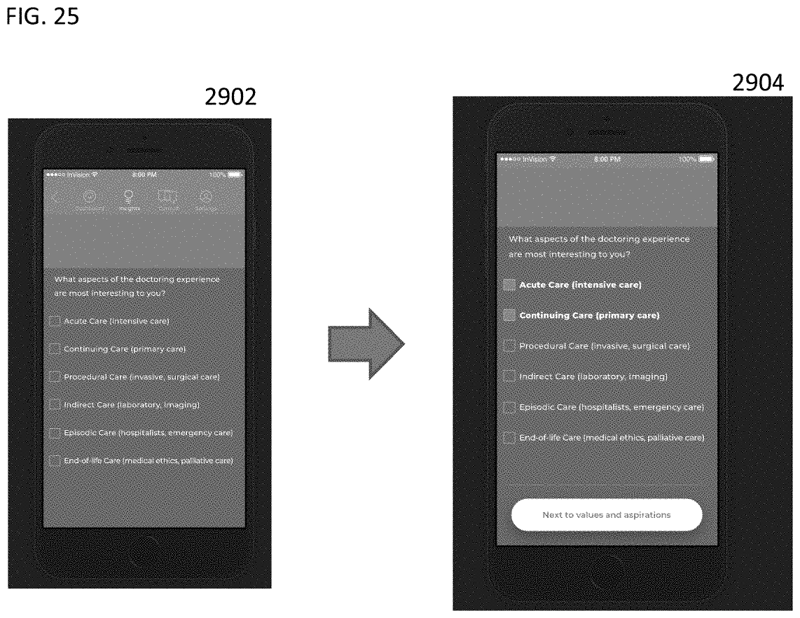

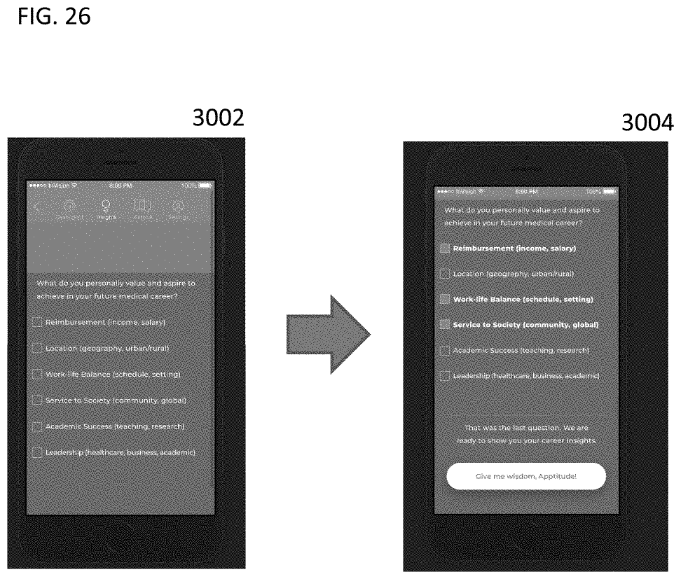

FIG. 25-26, continues with the collection of data relating to the users. As shown in 2902 and 2904, the user's selections can be made such that a collection of data is updated to an analytic server for further processing and analysis. Likewise, the user selections are recorded 3002 and 3004 for further use with the analytic platforms.

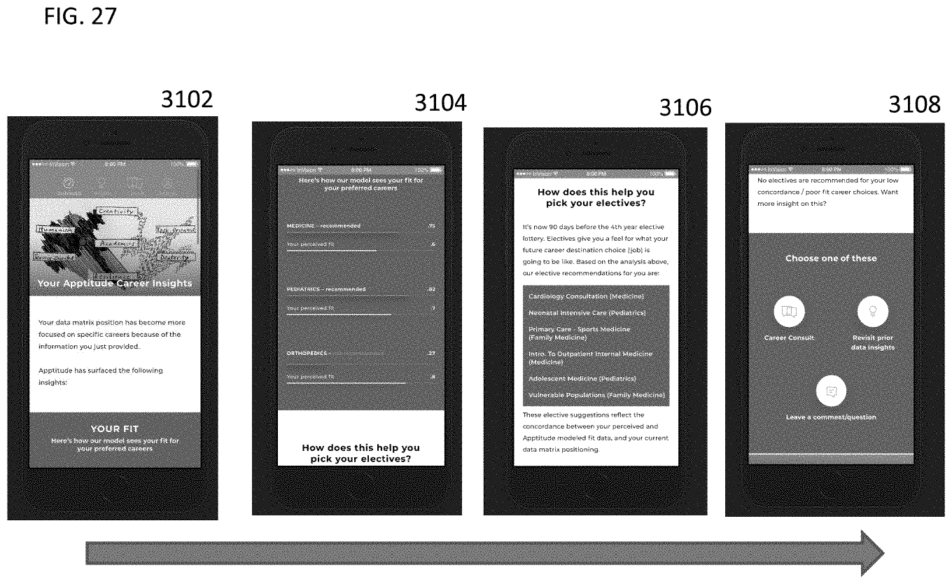

As shown in FIG. 27, the software application is configured to evaluate the user based on the user's selection of information. For example, 3102, 3104 provide information that correlates the user's input with the recommend outcome provided based on the user's existing evaluation dataset. These results are further explained in a dynamically updated user interface as shown in 3106-3108).

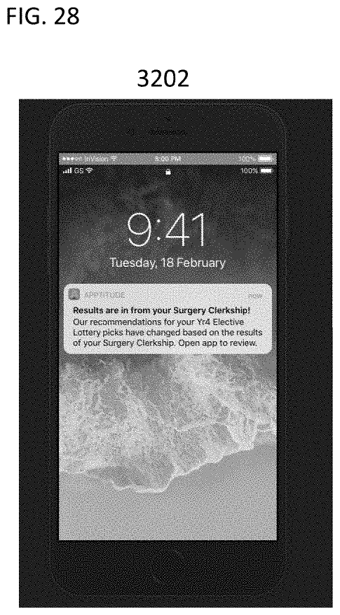

As shown in FIG. 28, Based on the user's selection of data and the processing of that data, the software application is configured to generate messages (3202) to the user regarding recommendation determined based on the information accessible to the user.

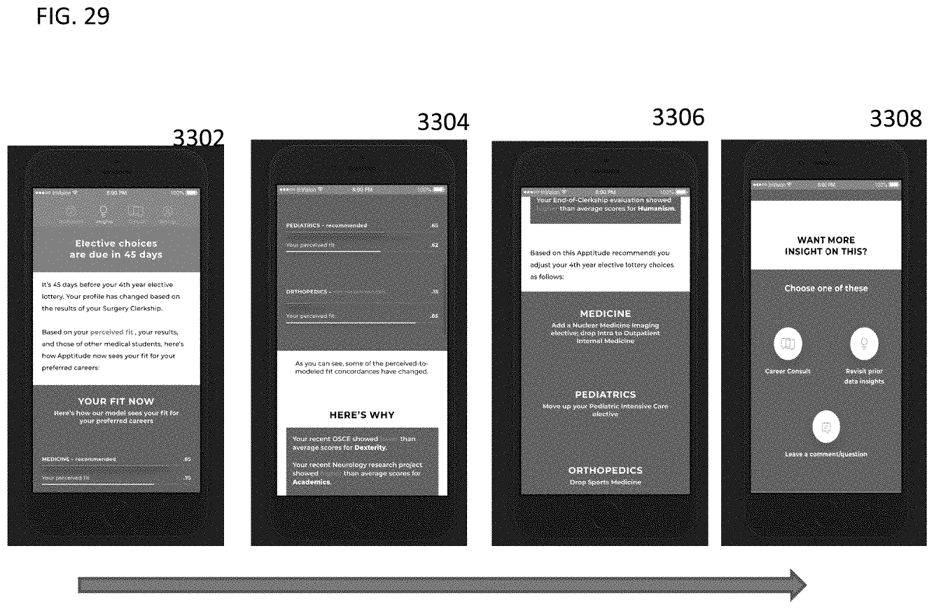

As shown in FIG. 29, the software application is configured to evaluate the user based on the user's selection of information in light of one or more upcoming dates. For example, based on the analysis of the information provided by the user, both in the software application and based on backend information, the user interface is updatable to indicate certain correlations between the user and the information. For example, 3302, 3304, 3306 and 3308 provide correlations between the user and one or more user categories or rankings of users.

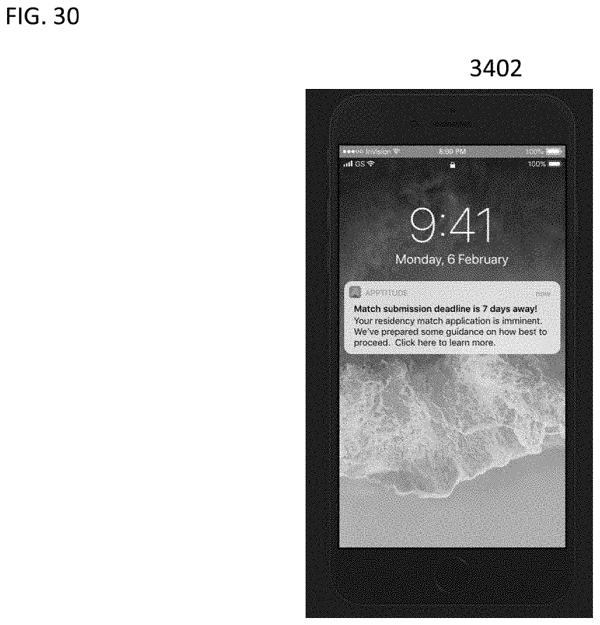

As shown in FIG. 30, based on the user's selection of data and the processing of that data, the software application is configured to generate messages (3402) to the user regarding recommendation determined based on the information accessible to the user as the result of an upcoming.

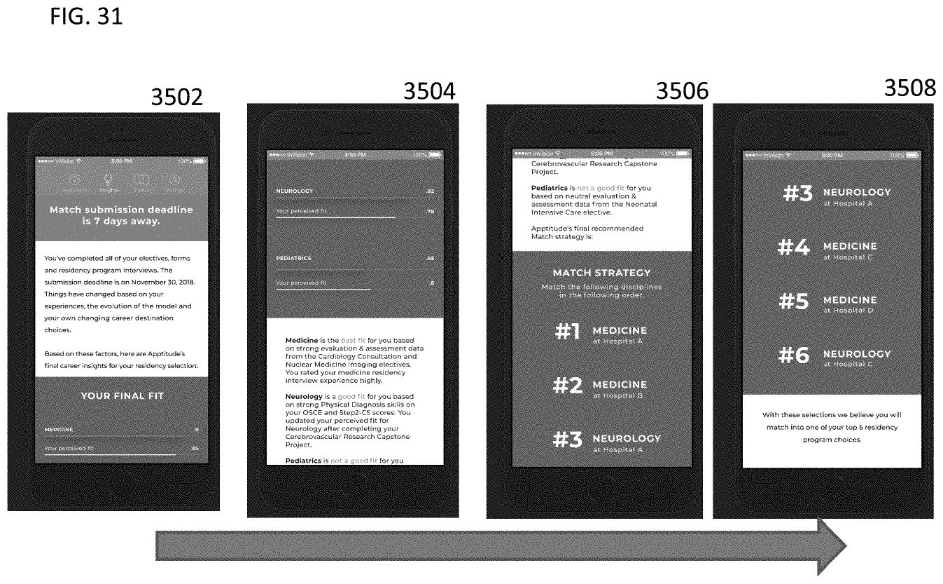

As shown in FIG. 31, the software application is configured to update the evaluation of the user based on the user's selection of information in light of one or more upcoming dates. For example, where the user was correlated to other users in FIG. 34, the user's data in FIG. 35 is updated based on proximity to a relevant event in time. For instance, where the user is a looking to match a particular educational program, the software is configured to update the correlation between the user's substantially similar to the present user and one or more of the different educational programs. For example, 3502, 3504, 3506 and 3508 provide correlations between the user and one or more user programs or categories of program based, in part, on the proximity in time to the event.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

The foregoing references, all of which are herein incorporated by reference in their entireties, highlight the state of the current art and are exemplary of the problems that the present invention overcomes and solves using one or more technical means described herein: Densen, P. Challenges and Opportunities Facing Medical Education. Transactions of the Am. Clin. Climatol. Assoc. 2011; 122: 48-58; Association of American Medical Colleges (AAMC) NEWS, Mar. 14, 2017; U.S. Bureau of Labor Statistics, 2015; American Nurses Association (ANA)2018www.nursingworld.org/MainMenuCategories/ThePracticeofProfessionalNursing/workforce/NursingShortage, Stegers-Jager, KM, Cohen-Schotanus, J, Themmen, APN. The Four-tier Continuum of Academic and Behavioral Support Model: An Integrated Model for Medical Student Success. Acad Med 2017; 92(11): 1525-1530; 2017 Medical School Graduate Questionnaire, All schools Summary Report. Association of American Medical Schools (AAMC), 2017. DOI:10.1111/medu.12499; Duvivier R J, Boulet J R, Opalek A, et al. Overview of the World's Medical Schools. Med. Educ. 2014 (Sep); 48(9): 860-869; The research on medical education outcomes (ROMEO) registry: Addressing ethical and practical challenges to using “bigger”, longitudinal educational data. Gillespie, C, Zabar, S, Altshuler, L, et al. Acad Med 2016; 91: 690-695. Artificial intelligence powers digital medicine. Fogel, A L, Kvedar, J C. Npj Digital Medicine 2018; 1: 5 https://doi:10.1038/s41746-017-0012-2; Miller, D D, Brown, E W. Artificial Intelligence in Medical Practice: The Question to the Answer? Am. J. Medicine, 131 (2); 2018 https://doi.org/10.1016/j.amjmed.2017.10.035; Li, L, Glicksberg, B S, Gottesman, O, et al. Identification of type 2 diabetes subgroups through topological analysis of patient similarities. Sci Trans Med 7(311): 311ra174 https://DOI:10.1126/scitranslmed.aaa9364; Deo, R. C. Machine Learning in Medicine. Circulation 2015; 132: 1920-1930; American Society for Engineering Education (ASEE) Member School Profiles, 2016 www.asee.org/colleges; American Bar Association (ABA) Section of Legal Education Required School Disclosures, 2018 www.abarequireddisclosures.org; National Association for Law Placement (NALP) Directory of Law Schools, April 2017 www.nalplawschoolsonline.org and www.nalpcanada.com; Association to Advance Collegiate Schools of Business (AACSB) Benchmarking Tools, 2018 www.aacsb.edu/knowledge/data/datadirect/benchmarking%20tools; Family Education Rights and Privacy Act (1974) http://www2.ed.gov/ferpd; Student Privacy 101: Student Privacy at the .S. Department of Education (2018) https://studentprivacy.ed.gov/; and FERPA Compliance on AWS (Amazon Web Services), December 2017. https://d0.awsstatic.com/whitepapers/compliance/AWS_FERPA_Whitepaper.pdf.

1. A system for evaluating an educational state of an individual comprising:
a training database, wherein the training database includes, for each member of a training population comprised of students currently enrolled at one or more educational institutions, an training assessment dataset that includes at least data relating to at least one performance metric of a respective member the training population obtained at a first time, and an outcome dataset including at least one status classifier associated by the respective member of the training population at a second time, wherein the second time is subsequent to the first time;
a training system, including an expert system module configured to determine correlations between the at least one performance metric of each member of the training population and the at least one status attained by each respective member of the training population between; and
a user platform database configured to provide at least user assessment data relating to at least one user performance for one or more users;
a computer system communicatively coupled to the training system and the user platform database, the computer system adapted to receive assessment data for at least one of the one or more users and provided by the user platform, and to assign at least one status classifier for the at least one of the one or more users using the correlations obtained from the training system.

2. The system of claim 1, wherein the training assessment dataset and the user assessment dataset includes one or more of, demographic data, geographic data or institution data for each respective member of the training population and the one or more users.

3. The system of claim 1, wherein the expert system module is an artificial neural network, the artificial neural network comprised of one or more node layers, each node layer configured to receive one or more input values and pass one or more output values to a subsequent node layer.

4. The system of claim 3, wherein the artificial neural network as at least 1 input layer, 1 hidden layer and 1 output layer.

5. A method comprising:
a) storing information in a standardized format about a student's performance one or more performance metrics in a plurality of network-based non-transitory storage devices having a collection of student records stored thereon;
b) providing remote access to a plurality of users over a network so any one of the users can update the information about the student's performance metrics in the collection of student records in real time through a graphical user interface, wherein the one of the users provides the updated information in a non-standardized format dependent on the hardware and software platform used by the one of the users;
c) converting, by a content server, the non-standardized updated information into the standardized format,
d) storing the standardized updated information about the student's performance condition in the collection of student records in the standardized format;
e) automatically generating a message containing the updated information about the student's performance by the content server whenever updated information has been stored; and
f) transmitting the message to all of the plurality of users over the computer network in real time, so that the plurality of users has real-time access to up-to-date student information.

6. The method of claim 5, further comprising the step of applying the standardized information about the student's performance condition to a pre-trained evaluation model and obtaining a predictive status relating to the student, wherein the pre-trained evaluation model is configured to correlate standardized information about one or more students to a predicted student status; and
including the predictive status of the student in the generated message.

7. The method of claim 6, further comprising, providing to an integrated curriculum management system configured to record student enrollment in one of a plurality of courses offered for instruction, the predictive status of the student,
altering, by the integrated curriculum management system, an enrollment status for at least one course enrolled in by the student based on the provided predictive status of the student;
generating a course alteration message that indicates the altered enrollment status,
transmitting the altered enrollment status to at least the student.

8. The method of claim 8 wherein, the enrollment status for the one of a plurality of courses is changed from an enrolled status to an unenrolled status or from an unenrolled status to an enrolled status.

9. A distributed categorization system is provided that comprises:
at least one electronic database having one or more performance assessment data associated with a plurality of entities matriculated at one or more educational institutions;
a processor, communicatively coupled to the at least one database, and configured to execute an electronic process that analyzes and converts said performance assessment data; said electronic process comprising:
selecting performance assessment data corresponding to at least:
(a) at least one structured assessment data value; and
(b) at least one unstructured assessment data set for an individual;
evaluating the structured and un-structed data of the individual using an assessment model configured to classify the entity into one of a plurality of assessment categories; and
generating a graphical representation of the likelihood that the individual is assigned to one of the plurality of assessment categories.

10. The system of claim 9, wherein the graphical representation is a 2-, or 3-dimensional virtual representation of the assessment categories.

11. The system of claim 9, further comprising:
comparing the classified assessment value against pre-determined threshold value; where the classified value is below the pre-determined threshold, adjusting at least a portion of the structured assessment value by a pre-determined amount; and reevaluating the adjusted structured assessment value and at least one unstructured assessment with the assessment module; where the adjusted assessment value has a classified assessment value above the pre-determined threshold value.

12. The system of claim 11, value of difference in the value of the structured assessment value and the adjusted assessment value.

13. The system of claim 11, further comprising the step of generate a new academic plan configured to move the learner calculated difference from the structured assessment value to the adjusted assessment value.

14. The system of claim 13, wherein the step of evaluating the unstructured data includes:
converting the unstructured data into a structured data set,
accessing a predictive model configured to classify the converted unstructured data; and
outputting one or more data values associated with the converted unstructured data.

15. The system of claim 14, converting the unstructured data includes evaluating the unstructured data using one or more natural language processing algorithms, generating sentiment score relating thereto and assigning the unstructured data to one of a plurality of sentiment categories, each category having a numerical value associated therewith.

16. The system of claim 14, wherein the predictive model is generated by accessing a database of historical unstructured data entries, where data entry has an associated value representing an outcome state.

17. The system of claim 15, wherein the outcome state corresponds to employment status in a preferred discipline within a pre-determined threshold number of years after completion of an educational program.

18. The system of claim 15, wherein the outcome state corresponds to future career stability for a pre-determined threshold number of years after employment in a preferred discipline.

19. (canceled)

20. (canceled)
